(19) United States
(12) Patent Application Publication
(10) Pub. No.: US 2024/0406705 A1
(43) Pub. Date: Dec. 5, 2024

(54) SYSTEMS AND METHODS FOR HARDWARE SUBSCRIPTION USER INTERFACES

(71) Applicant: Apple Inc., Cupertino, CA (US)

(72) Inventors: John N. VIDNOVIC, San Francisco, CA (US); Bryan J. WEGMAN, Boulder Creek, CA (US); Monica C. GRAU-PARKER, San Jose, CA (US)

(21) Appl. No.: 18/679,262

(22) Filed: May 30, 2024

Related U.S. Application Data
(60) Provisional application No. 63/506,067, filed on Jun. 3, 2023.

(51) Int. Cl. H04W 8/18; G06F 3/0482; H04M 15/00

(52) U.S. Cl. CPC H04W 8/18; G06F 3/0482; H04M 15/44

(57) ABSTRACT

Some embodiments described in this disclosure are directed to user interfaces for subscribing to a hardware subscription. Some embodiments described in this disclosure are directed to user interfaces for managing subscriptions, including hardware subscriptions.

### CROSS-REFERENCE TO RELATED APPLICATIONS

This application claims the benefit of U.S. Provisional Application No. 63/506,067, filed Jun. 3, 2023, the content of which is herein incorporated by reference in its entirety for all purposes.

### FIELD OF THE DISCLOSURE

This relates generally to electronic devices that present user interfaces for subscribing to, viewing details about, modifying, and/or canceling subscriptions to access and/or use electronic devices.

### BACKGROUND

User interaction with electronic devices has increased significantly in recent years. These devices can be devices such as computers, tablet computers, televisions, multimedia devices, mobile devices, and the like.

In some circumstances, users wish to subscribe to, view details about, edit, and/or cancel subscriptions to access and/or use electronic devices. Enhancing these interactions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### SUMMARY OF THE DISCLOSURE

Some embodiments described in this disclosure are directed to an electronic device that displays user interfaces for managing hardware subscriptions that entitle the subscriber to use an electronic device. The full descriptions of the embodiments are provided in the Drawings and the Detailed Description, and it is understood that the Summary provided above does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6U illustrate exemplary ways of managing hardware subscriptions in accordance with some embodiments of the disclosure.

FIG. 7 is a flow diagram illustrating a method of managing hardware subscriptions in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that enable the user to manage hardware subscriptions. Such techniques can reduce the cognitive burden on a user who uses such devices and/or wishes to control their use of such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

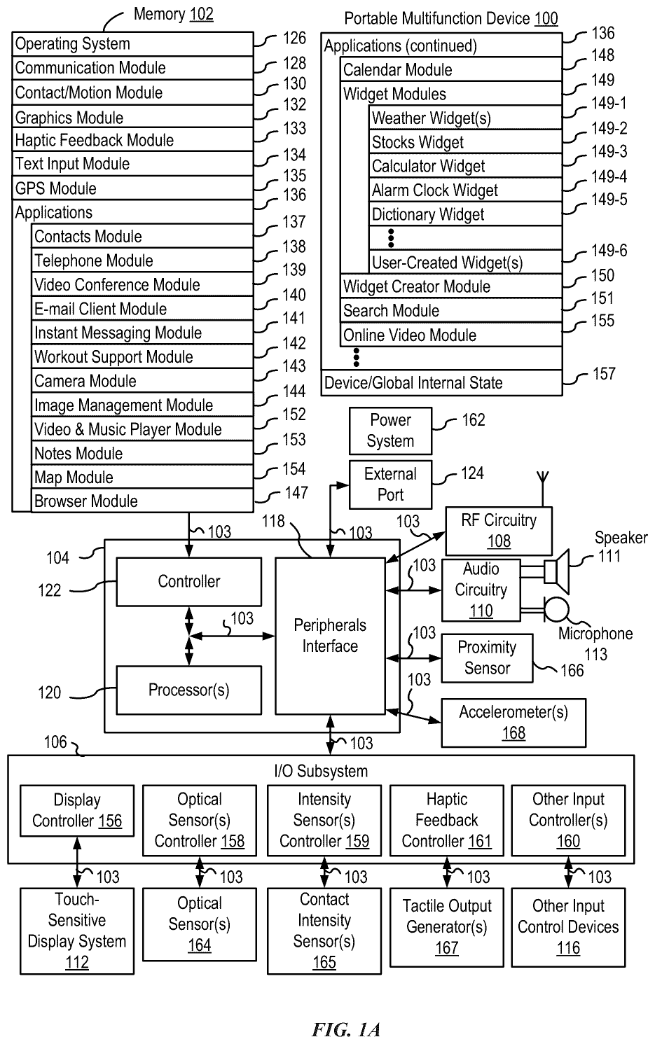

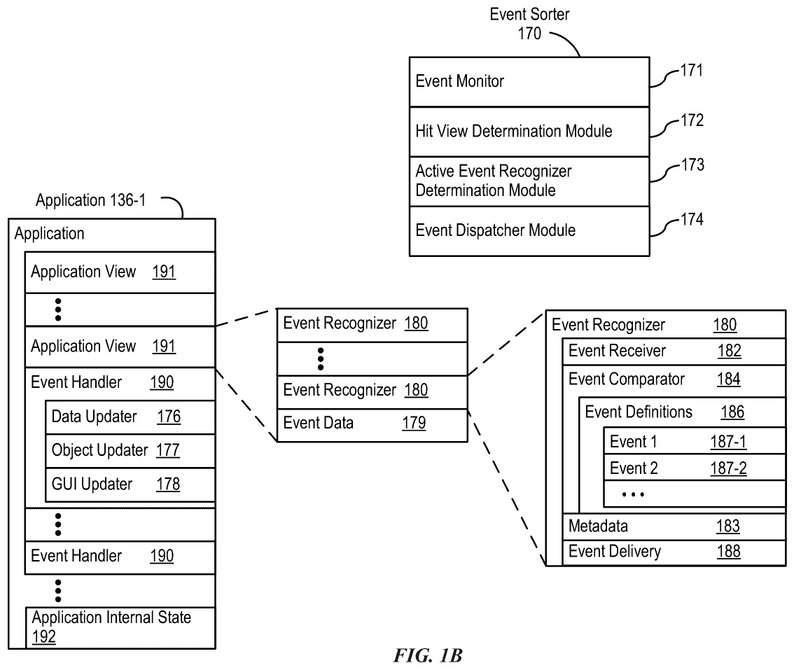

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

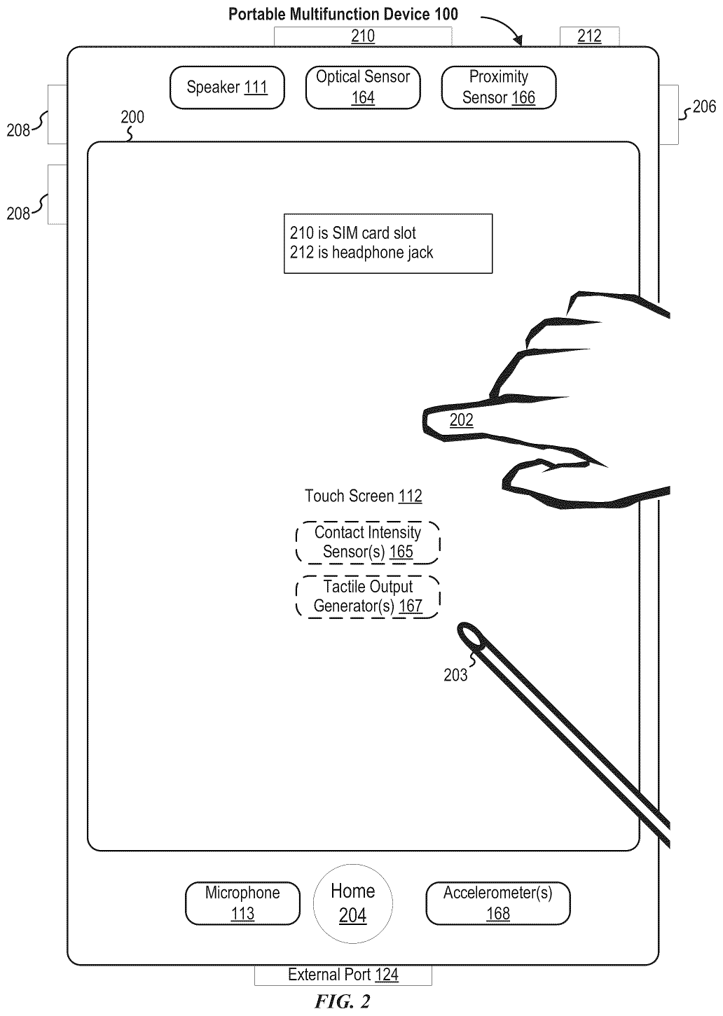

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

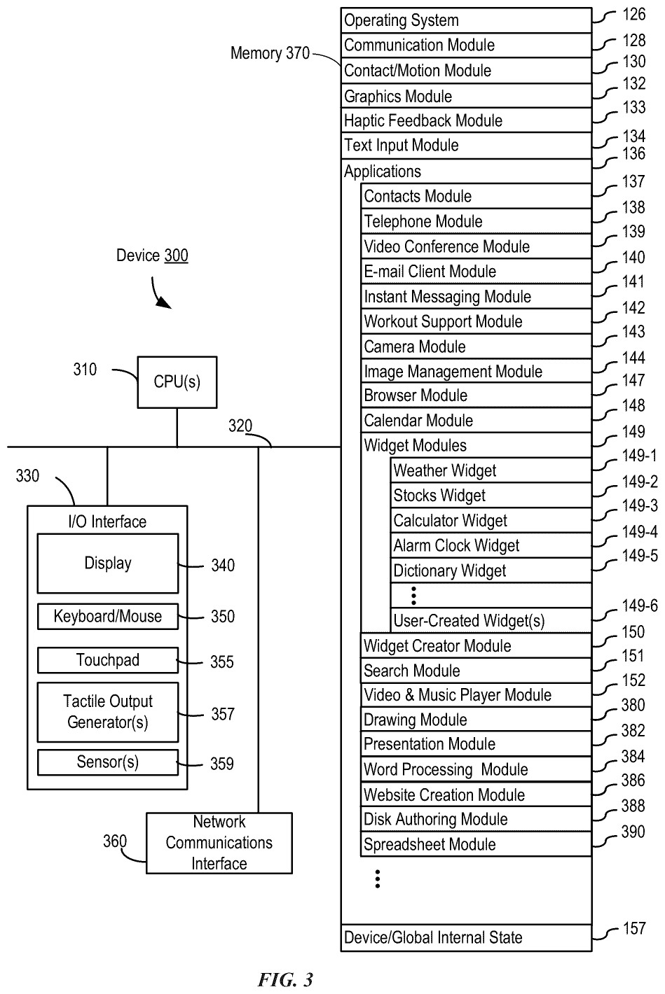

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

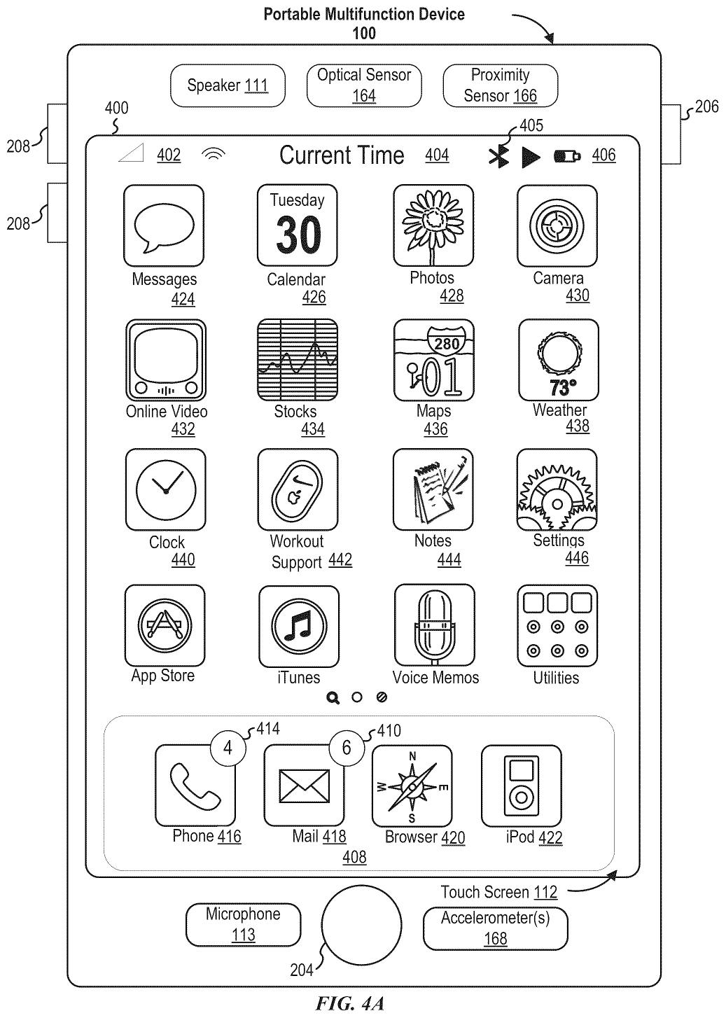

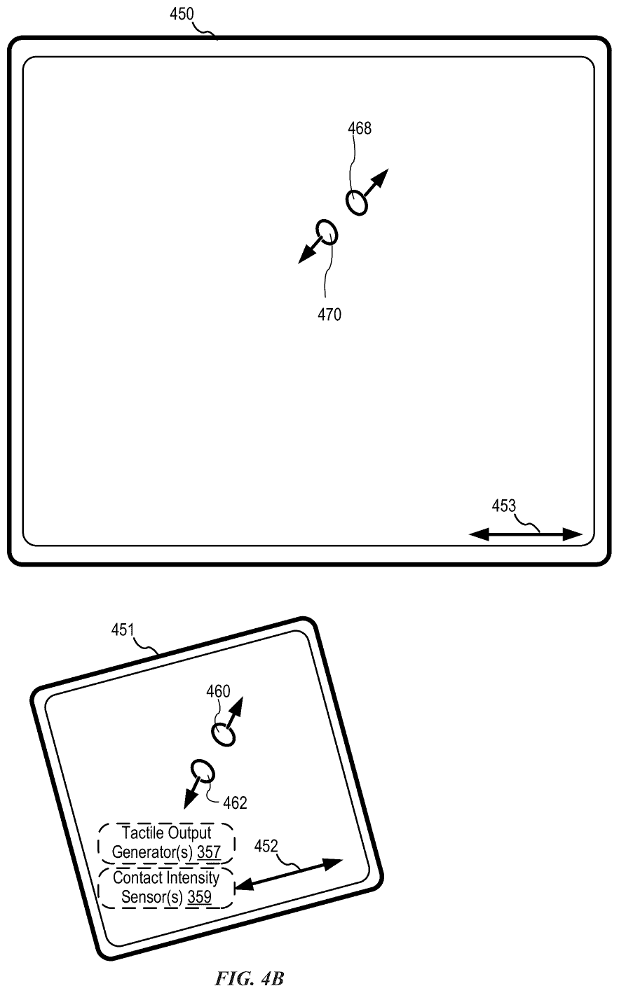

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

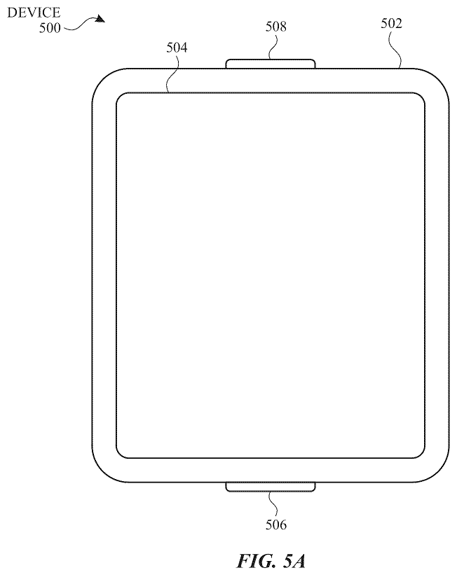

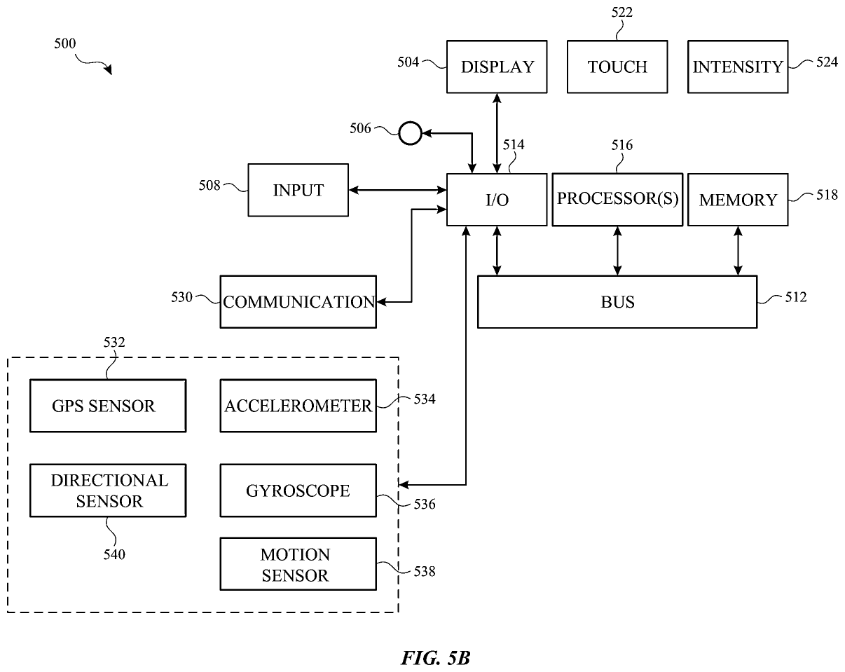

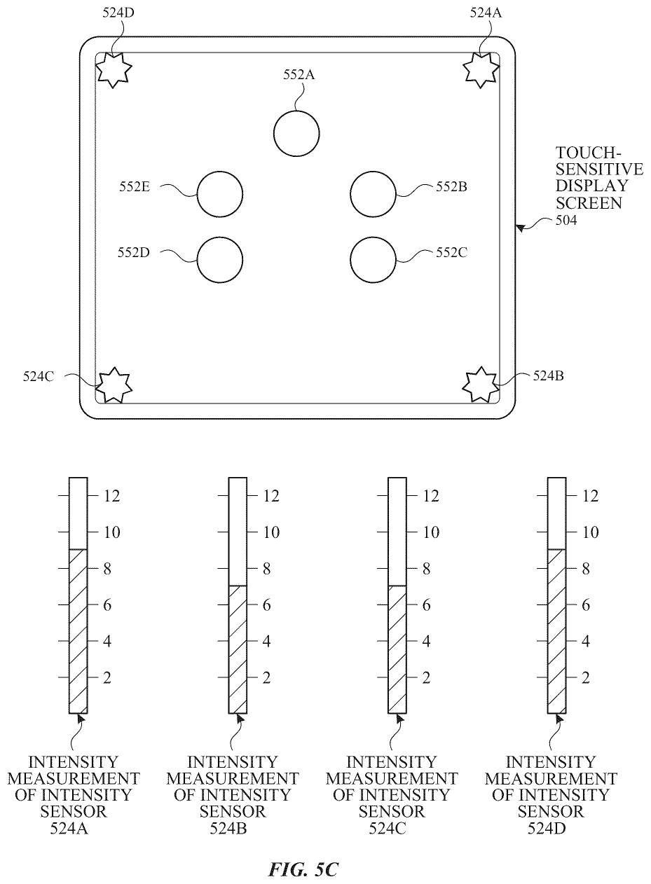

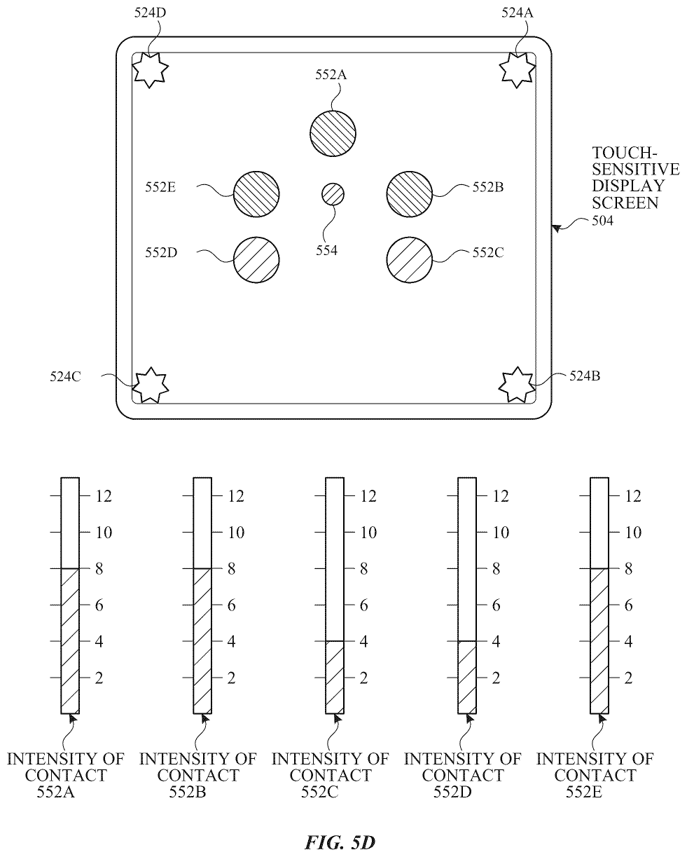

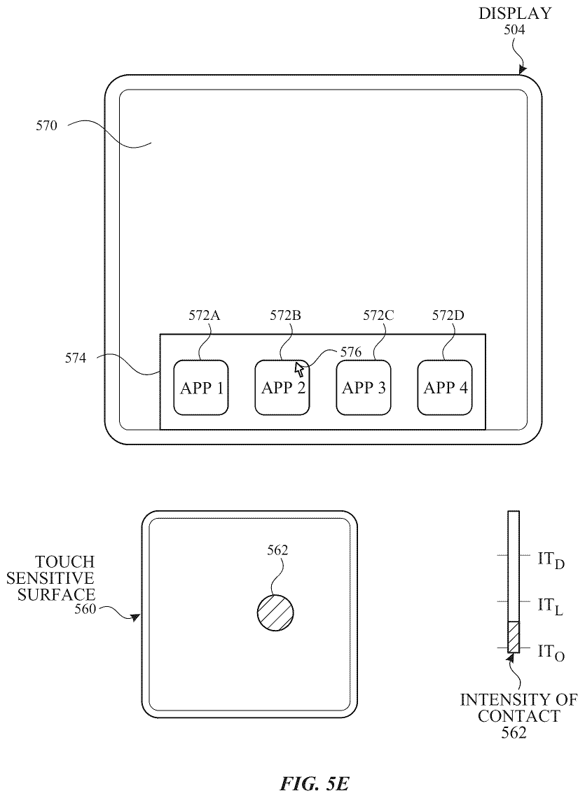

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, carrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

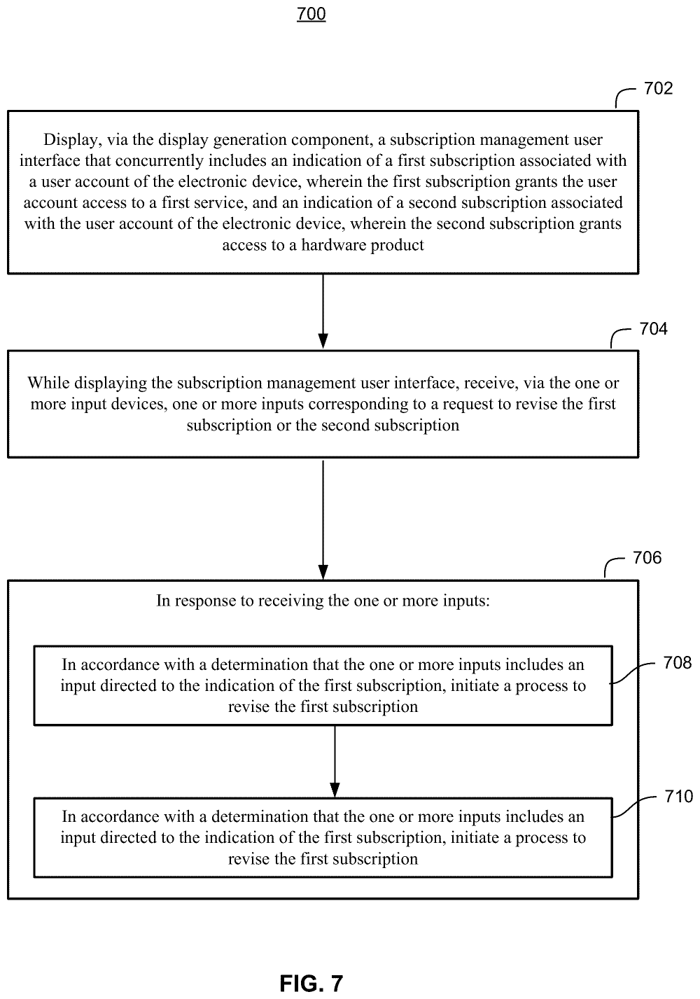

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D})”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D})”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### User Interfaces for Hardware Subscriptions

Users interact with electronic devices in many different manners. In some embodiments, a user may wish to lease an electronic device, rather than purchasing an electronic device. The embodiments described below provide ways in which an electronic device presents user interfaces for hardware subscriptions (e.g., leasing an electronic device). Enhancing interactions with a device reduces the amount of time needed by a user to perform operations, and thus reduces the power usage of the device and increases battery life for battery-powered devices. The techniques described herein enhance a user's ability to initiate, view, edit, and/or cancel subscription access to a hardware device. It is understood that people use devices. When a person uses a device, that person is optionally referred to as a user of the device.

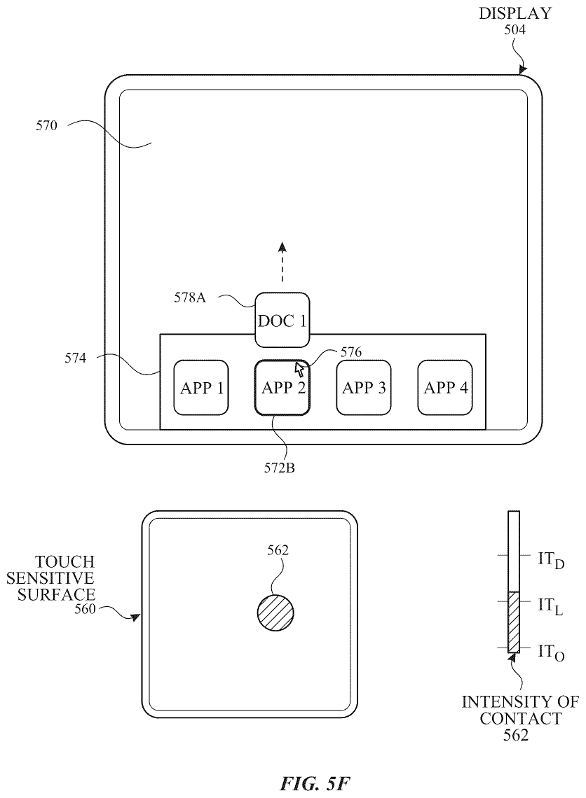

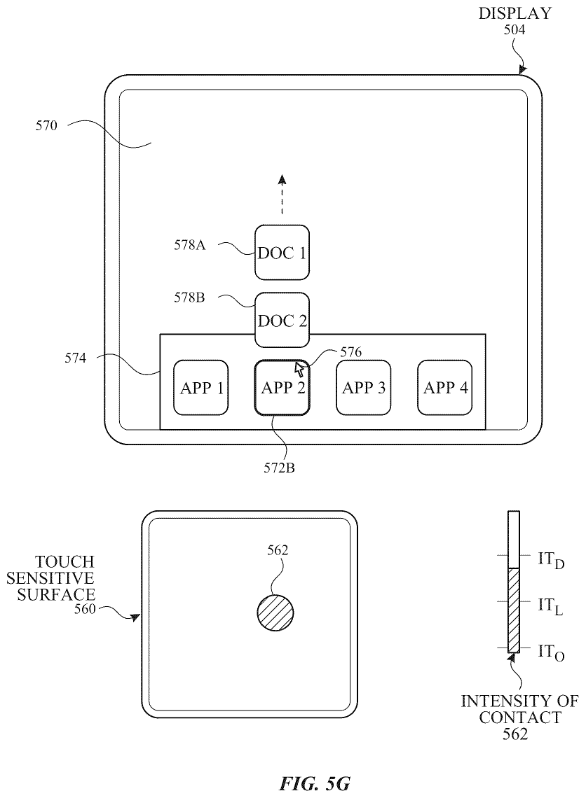

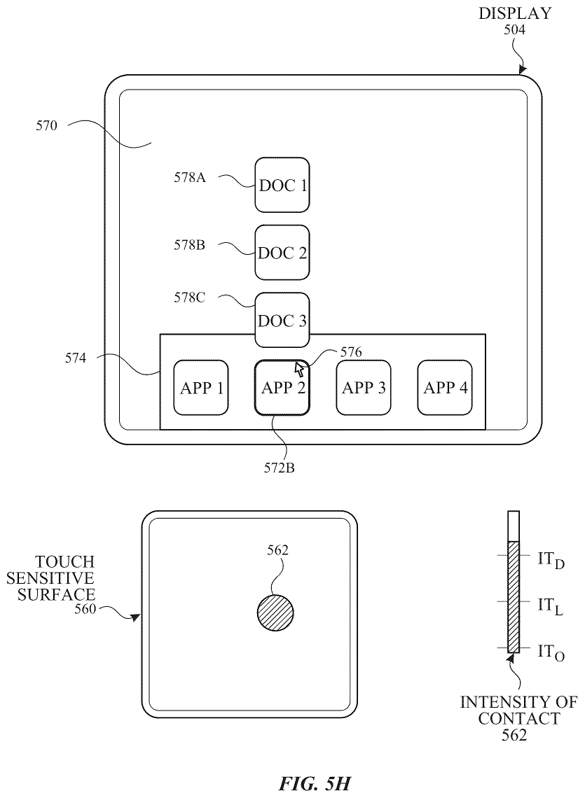

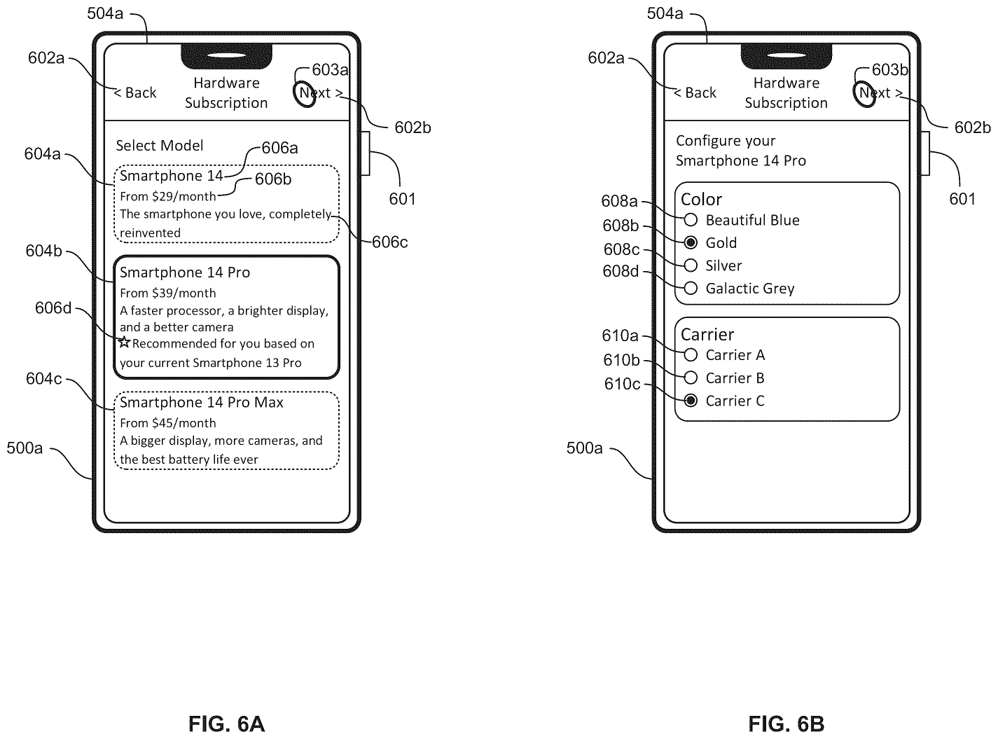

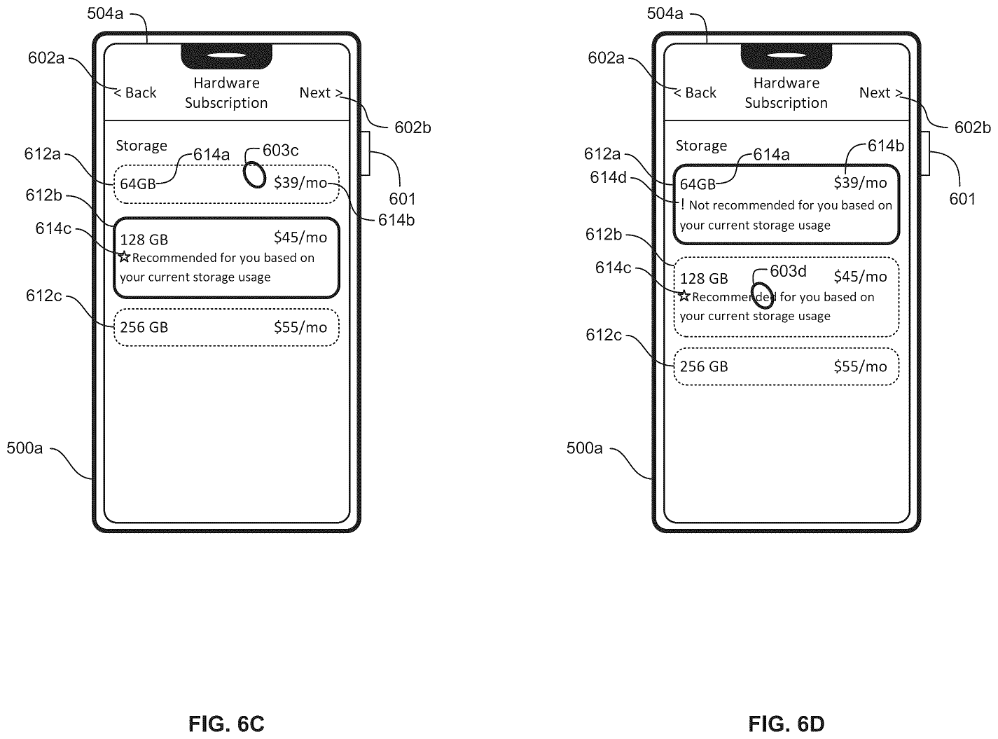

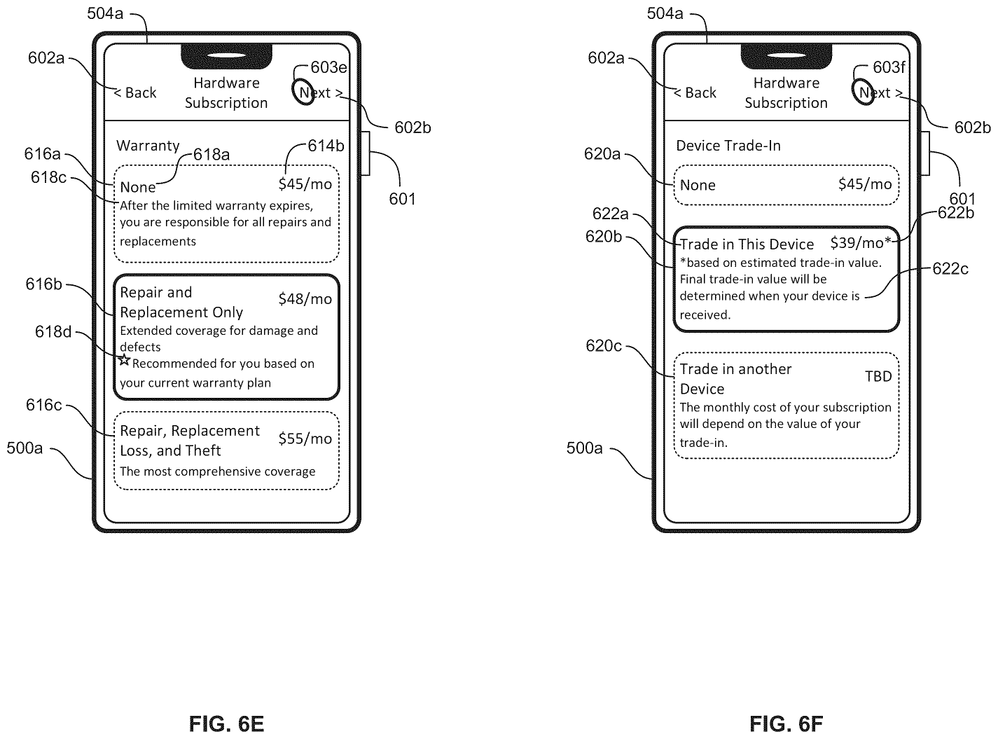

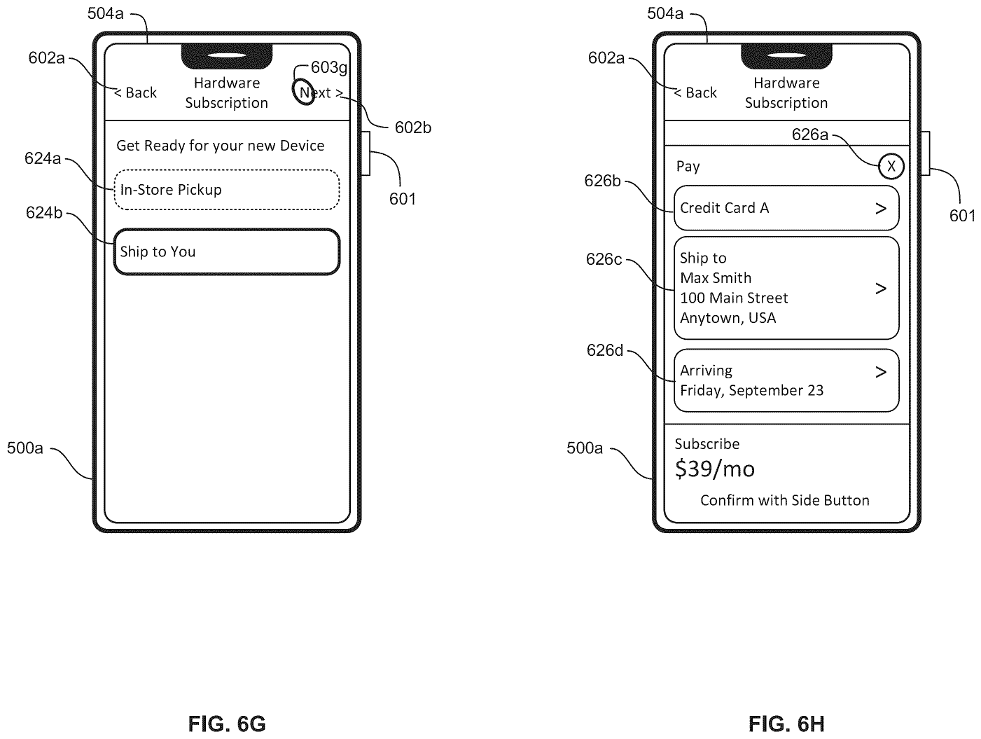

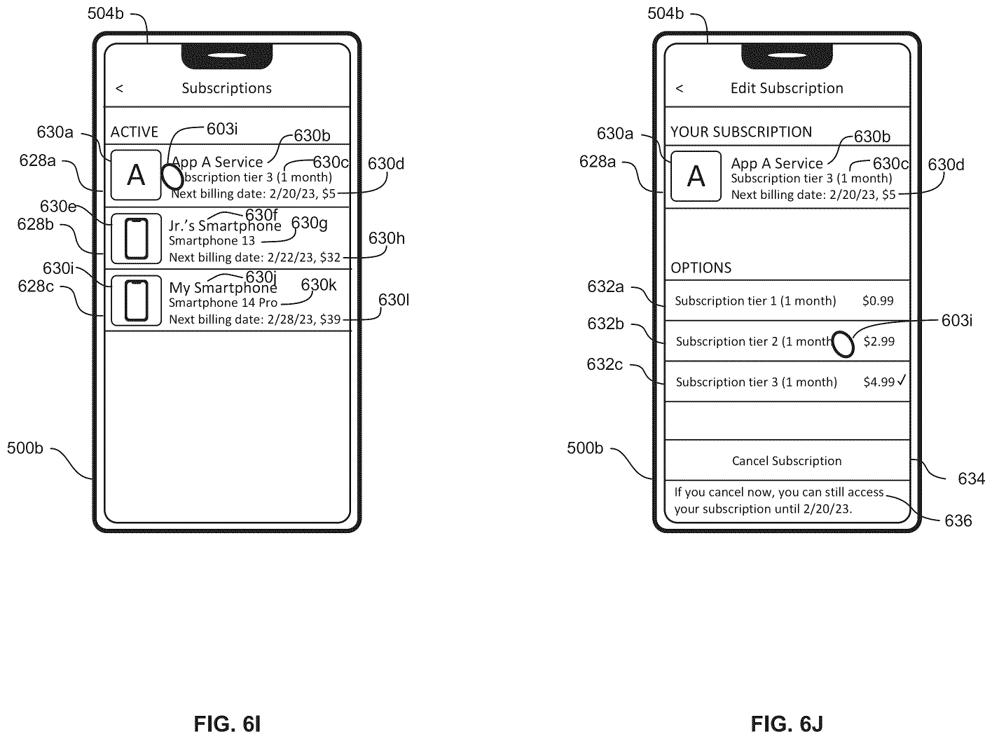

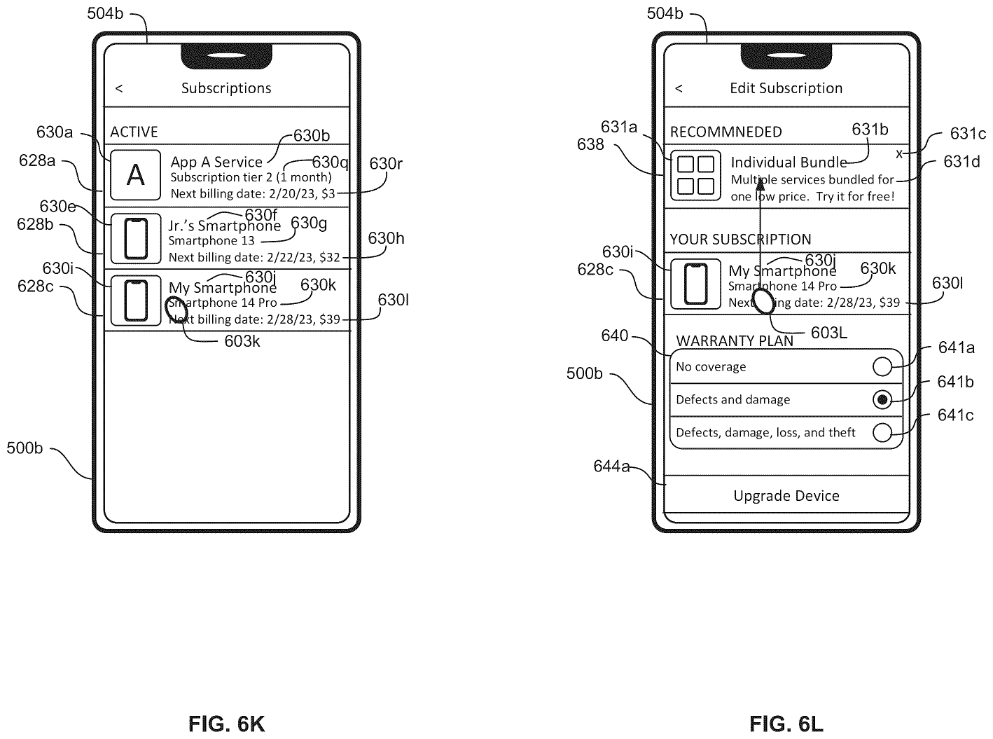

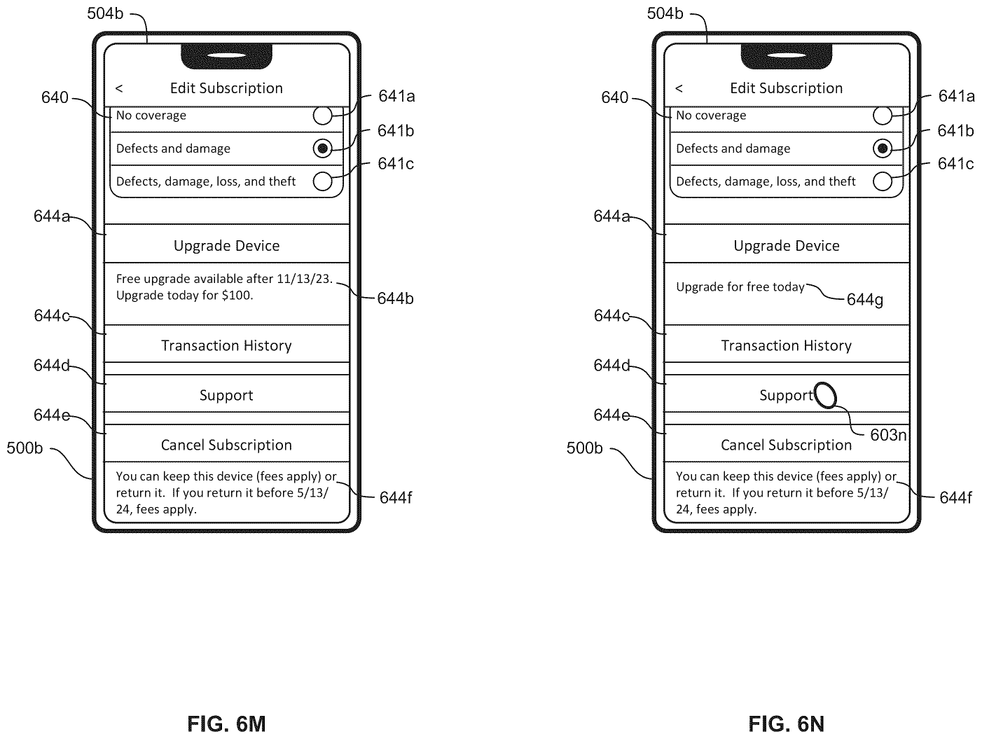

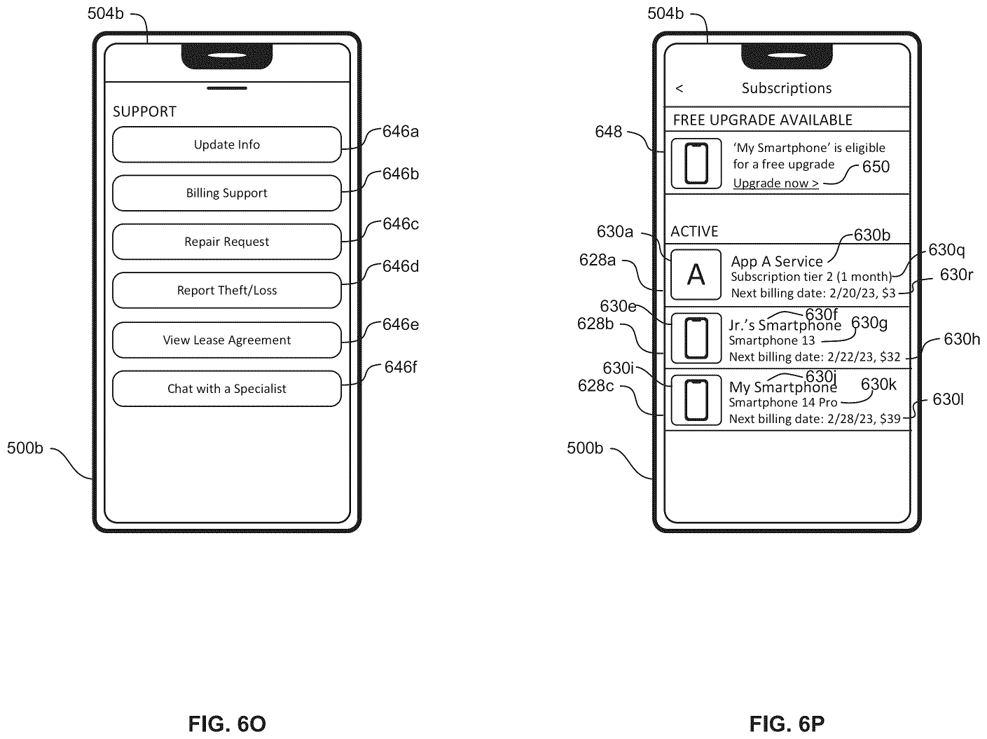

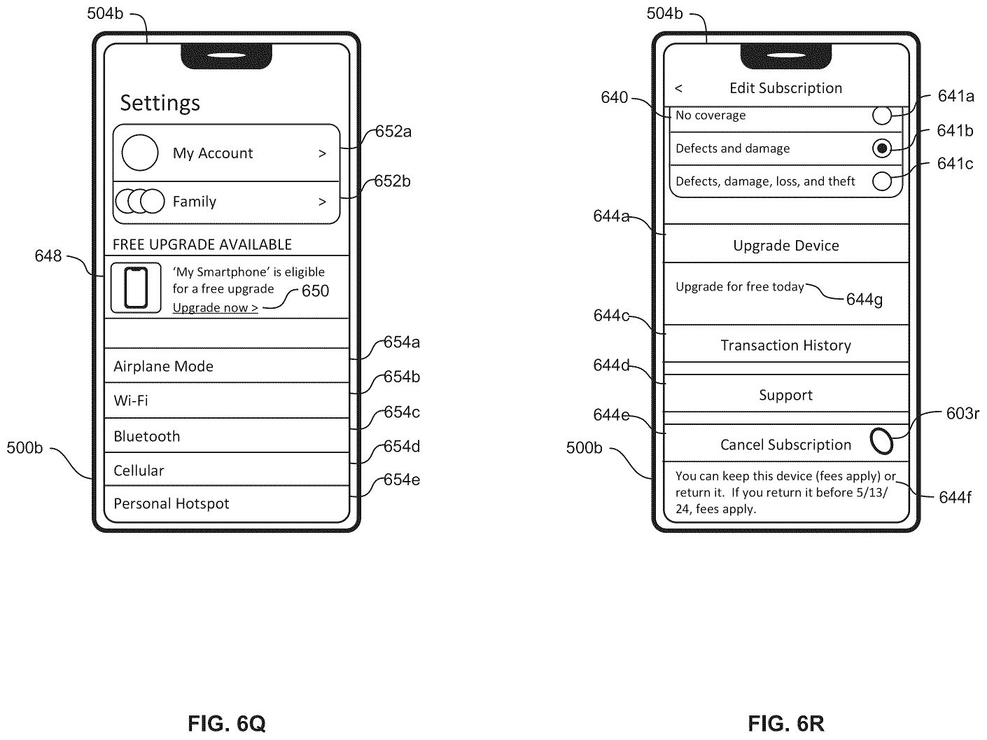

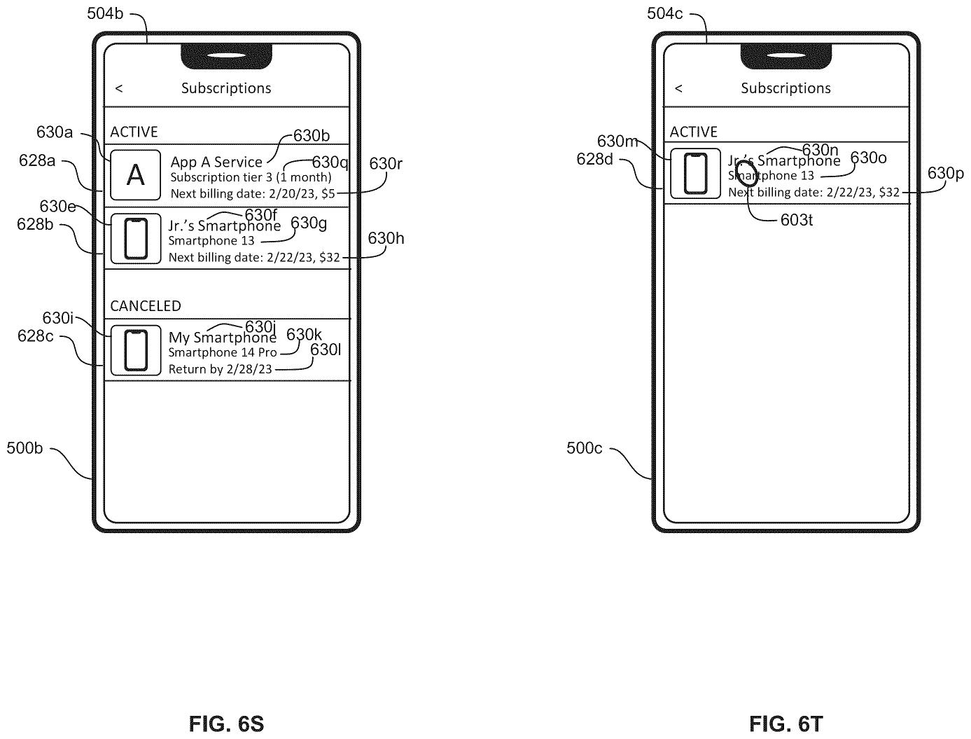

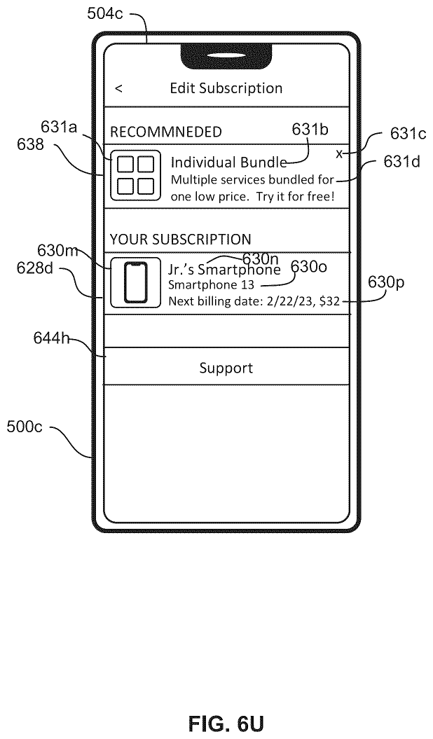

FIGS. 6A-6U illustrate exemplary ways of managing hardware subscriptions in accordance with some embodiments of the disclosure. The embodiments in these figures are used to illustrate the processes described below, including the processes described with reference to FIG. 7. These figures are not meant to be limiting; other user interfaces are possible in accordance with method 700 without departing from the scope of the disclosure.

FIGS. 6A-6H illustrate an example electronic device 500a displaying user interfaces for enrolling in a hardware subscription. As shown at least in FIG. 6A, the electronic device 500a includes a touch screen 504a. In FIG. 6A, the electronic device 500a displays a user interface including selectable options 604a, 604b and 604c associated with electronic devices available for rental through a hardware subscription. In some embodiments, enrollment in a hardware subscription entitles the user to access and use hardware (e.g., an electronic device, such as electronic device 500a) for a monthly fee without the user purchasing the hardware. In some embodiments, while the subscription is active, the user does not own the hardware. In some embodiments, the electronic device 500a displays the user interface in FIG. 6A in response to an input corresponding to a request to enroll in a hardware subscription. In some embodiments, the input is directed to a selectable option displayed in a user interface, such as a webpage displayed in an internet browsing application, an online store application, or a subscription management user interface.

As shown in FIG. 6A, the user interface includes selectable options 604a through 604c associated with different hardware products available for access using a hardware subscription. In some embodiments, the hardware products are of the same or similar architecture or category. For example, in FIG. 6A, the hardware products associated with selectable options 604a through 604c are different models of smartphones. In some embodiments, other types of devices are available for subscription access, such as tablets, desktop and laptop computers, set top boxes, and/or wearable devices (e.g., smart watches and/or head-mounted display devices). In some embodiments, the user interface includes selectable options associated with electronic devices of different types, such as the user interface including selectable option(s) associated with a mix of the device types listed above.

In some embodiments, the selectable options 604a through 604c include information about the associated electronic device. For example, option 604a includes an indication 606a of the model of the electronic device, an indication 606b of the monthly fee for accessing the device on a subscription plan, and a description 606c of the electronic device. In some embodiments, the electronic device 500a automatically selects one of the selectable options 6046 based on which model of the same category of device the user has associated with their user account. For example, in FIG. 6A, option 604b associated with “Smartphone 14 Pro” is selected when the electronic device 500a initially displays the user interface, without the electronic device 500a receiving a user input selecting option 604b, because it is similar to a smartphone already associated with the user's account. As shown in FIG. 6A, selectable option 604b includes an indication 606d that the electronic device associated with selectable option 604b is recommended to the user based on the smartphone the user has associated with their account and is displayed with a different line style from the line style of options 604a and 604c, which are not currently selected. Additionally or alternatively in some embodiments, the electronic device 500a uses a visual characteristic other than line style to indicate which option is selected, such as background color, text style/color, translucency, and/or the presence or absence of a visual indication indicating selection.

As shown in FIG. 6A, the user interface further includes a back option 602a and a next option 602b. In some embodiments, in response to detecting selection of the back option 602a, the electronic device 500a navigates back in the user interface to the user interface displayed prior to the user interface in FIG. 6A. In some embodiments, in response to detecting selection of the next option 602b, the electronic device 500a displays a user interface with the next set of options for the user to select to set up the hardware subscription. As shown in FIG. 6A, while option 604b is selected, the electronic device 500a detects selection (e.g., by contact 603a) of the next option 602b. In response to the input illustrated in FIG. 6A, the electronic device 500a saves the user's selection and displays the user interface illustrated in FIG. 6B.

FIG. 6B illustrates the electronic device 500a displaying a user interface for selecting color and carrier options for a hardware subscription in response to the input illustrated in FIG. 6A. As shown in FIG. 6B, the user interface includes options 608a through 608d for selecting a color for the electronic device accessed by the subscription and options 610a through 610c of cellular service carriers for the electronic device accessed by the subscription. In some embodiments, options for other characteristics of the electronic device to be accessed by subscription are possible. For example, for subscription access to a tablet computer, the user interface includes options for device color, connectivity (e.g., Wi-Fi only or Wi-Fi and cellular), cellular service carrier, and/or whether or not to lease an accessory (e.g., keyboard, stylus, and/or protective case) with the subscription access to the tablet computer. As another example, for a head-mounted display device, the user interface includes options for device color, prescription lenses, and/or pupillary distance. Other options, including but not limited to device-specific options are possible. In some embodiments, in response to detecting selection of different ones of options 608a through 608d and/or 610a through 610c, the electronic device 500a configures the subscription in accordance with the selected option. For example, in response to detecting selection of option 608a, the electronic device 500a configures the subscription to include a device that has the “beautiful blue” color, instead of the “gold” color associated with option 608b. As shown in FIG. 6B, while options 608b and 610c are selected, the electronic device 500a detects selection (e.g., by contact 603b) of the next option 602b. In some embodiments, in response to the input in FIG. 6B, the electronic device 500a saves the user's selections and displays the user interface in FIG. 6C.

FIG. 6C illustrates the electronic device 500a displaying a user interface for selecting storage options for a hardware subscription in response to the input illustrated in FIG. 6B. In some embodiments, the user interface includes options 612a through 612c associated with various amounts of storage available for the electronic device associated with the hardware subscription. For example, option 612a includes an indication 614a of the amount of storage and an indication 614b of the subscription price if that amount of storage is selected, and options 612b and 612c include similar components. In some embodiments, the electronic device 500a recommends an amount of storage based on current storage usage on an electronic device associated with the user account that is of the same type as the type of device of the electronic device associated with the hardware subscription. For example, in FIG. 6C, the electronic device 500a automatically selects option 612b, without receiving a user input selecting option 612b, based on how much storage the user is using on their smartphone because the hardware subscription is associated with a smartphone. Because the storage amount associated with option 612b is recommended, option 612b includes an indication 614c of the recommendation, including a reason for the recommendation (e.g., “based on your current storage usage”), as shown in FIG. 6C. As shown in FIG. 6C, because option 612b is selected, option 612b is displayed with a different line style from the other options 612a and 612c. Additionally or alternatively in some embodiments, the electronic device 500a uses a visual characteristic other than line style to indicate which option is selected, such as background color, text style/color, translucency, and/or the presence or absence of a visual indication indicating selection.

In some embodiments, although the electronic device 500a recommends the amount of storage associated with option 612b, it is possible for the user to select a different amount of storage for the electronic device associated with the hardware subscription. For example, as shown in FIG. 6C, while option 612b is selected, the electronic device 500a detects selection (e.g., by contact 603c) of option 612a. As shown in FIG. 6C, option 612a is associated with a storage amount that is less than the recommended amount of storage. In response to the input illustrated in FIG. 6C, the electronic device 500a saves the user's selection and updates the user interface as shown in FIG. 6D.

FIG. 6D illustrates an example of the electronic device 500a displaying the updated user interface in response to the input illustrated in FIG. 6C. As shown in FIG. 6D, the electronic device 500a displays option 612a with a line style that is different from the line style of options 612b and 612c to indicate that option 612a is selected. Additionally or alternatively in some embodiments, the electronic device 500a uses a visual characteristic other than line style to indicate which option is selected, such as background color, text style/color, translucency, and/or the presence or absence of a visual indication indicating selection. As shown in FIG. 6D, while option 612a is selected, the electronic device 500a displays an indication 614d in option 612a indicating that the amount of storage corresponding to option 612a is not recommended. In some embodiments, the indication 614d includes an explanation of why the amount of storage is not recommended (e.g., “based on your current storage usage”).

In some embodiments, if the input in FIG. 6C had been selection of option 612c, the electronic device 500a would update option 612c to be displayed with the line style or other visual characteristic indicating that option 612c is selected and would display options 612a and 612b with the line style or other visual indication to indicate that those options are not selected. In some embodiments, while option 612c is selected, the electronic device 500a forgoes presenting an indication similar to indication 614d in option 612c because the amount of storage corresponding to option 612c is greater than the recommended amount. In some embodiments, while option 612c is selected, the electronic device 500a presents an indication similar to indication 614d in option 612c because the amount of storage corresponding to option 612c is greater than the recommended amount. In some embodiments, the electronic device 500a maintains display of indication 614c while an option other than option 612b (e.g., option 612a or option 612c) is selected.

As shown in FIG. 6D, the electronic device 500a detects selection (e.g., by contact 603d) of option 612b. In response to receiving a sequence of inputs including the input illustrated in FIG. 6D followed by selection of the next option 602b, the electronic device 500a displays the user interface illustrated in FIG. 6E.

FIG. 6E illustrates the electronic device 500a displaying a user interface for selecting warranty coverage for the electronic device associated with the hardware subscription in response to receiving the sequence of inputs described above with reference to FIG. 6D. As shown in FIG. 6E, the user interface includes selectable options 616a through 616c corresponding to different levels of warranty coverage for the electronic device associated with the hardware subscription. For example, option 616a includes an indication 618a of the name of the level of warranty coverage, an indication 614b of the cost of the subscription with that level of warranty coverage, and a description 618c of the level of warranty coverage. As shown in FIG. 6E, options 616b and 616c include similar components to those of option 616a.

In some embodiments, the electronic device 500a displays an indication 618d of a recommended level of warranty coverage that is based on the level of warranty coverage the user has for another electronic device, such as a device of the same type as the electronic device associated with the hardware subscription or a device of a different type as the electronic device associated with the hardware subscription. For example, as shown in FIG. 6E, option 616b includes indication 618d that indicates that the “repair and replacement” warranty plan is recommended. In some embodiments, the indication 618d includes a description of why that level is recommended (e.g., “based on your current warranty plan”). In some embodiments, the electronic device 500a initially displays the user interface in FIG. 6E with option 616b selected, without receiving a user input selecting option 616b, because option 616b is recommended based on the user's current warranty plan for another device. In some embodiments, the electronic device 500a initially displays the user interface in FIG. 6E without one of options 616a through 616c selected.

As shown in FIG. 6E, while option 616b is selected, the electronic device 500a displays option 616b with a different line style from the line style of options 616a and 616c. Additionally or alternatively in some embodiments, the electronic device 500a uses a visual characteristic other than line style to indicate which option is selected, such as background color, text style/color, translucency, and/or the presence or absence of a visual indication indicating selection.

As shown in FIG. 6E, while option 616b is selected, the electronic device 500a detects selection (e.g., by contact 603c) of option 602b. In response to the input illustrated in FIG. 6E, the electronic device 500a saves the user's selection and displays the user interface illustrated in FIG. 6F.

FIG. 6F illustrates the electronic device 500a displaying a user interface with device trade in options for the hardware subscription in response to the input shown in FIG. 6E. As shown in FIG. 6F, the user interface includes an option 620a to enroll in the subscription without trading in a device, an option 620a to enroll in the subscription including trading in the electronic device 500a that is displaying the user interface, and an option 620a to enroll in the subscription including trading in an electronic device other than the electronic device 500a that is displaying the user interface. For example, option 620b includes an indication 622a of the trade in associated with the hardware subscription, an indication 622b of the monthly subscription cost if option 620b is selected, and a text description 622c of the trade-in associated with option 620b. In some embodiments, options 620a and 620c include one or more components similar to the components of option 620b.

As shown in FIG. 6F, while option 620b is selected, the electronic device 500a displays option 620b with a different line style from the line style of options 620a and 620c. Additionally or alternatively in some embodiments, the electronic device 500a uses a visual characteristic other than line style to indicate which option is selected, such as background color, text style/color, translucency, and/or the presence or absence of a visual indication indicating selection. In some embodiments, the electronic device 500a selects option 620b by default without receiving a user input selecting option 620b. In some embodiments, the electronic device 500a initially displays the user interface without one of the options 620a through 620c selected, and selects option 620b in response to a user input selecting (e.g., with a contact) the option 620b. In some embodiments, the electronic device 500a initially displays the user interface with options 620a or option 620c selected, and selects option 620b in response to a user input selecting (e.g., with a contact) the option 620b.

As shown in FIG. 6F, while indication 622a is selected, the electronic device 500a detects selection (e.g., by contact 603f) of the next option 602b. In some embodiments, in response to the input illustrated in FIG. 6F, the electronic device 500a saves the user's selection and displays the user interface shown in FIG. 6G.

FIG. 6G illustrates the electronic device 500a displaying a user interface for pickup or delivery of the electronic device associated with the hardware subscription in response to the input illustrated in FIG. 6H. As shown in FIG. 6G, the user interface includes an option 624a to pick up the electronic device associated with the hardware subscription in person at a store and an option 624b to have the electronic device associated with the hardware subscription shipped to an address. In some embodiments, in response to detecting selection of option 624a, the electronic device 500a displays a user interface for selecting a store at which to pick up the electronic device associated with the hardware subscription. In some embodiments, in response to detecting selection of option 624b, the electronic device 500a displays a user interface for entering a shipping address. As shown in FIG. 6G, while option 624b is selected, the electronic device 500a displays option 624b is displayed with a different line style from option 624a. Additionally or alternatively in some embodiments, the electronic device 500a uses a visual characteristic other than line style to indicate which option is selected, such as background color, text style/color, translucency, and/or the presence or absence of a visual indication indicating selection.

In some embodiments, while option 624b is selected, the electronic device 500a detects selection (e.g., by contact 603g) of the next option 602b. In some embodiments, in response to the input in FIG. 6G, the electronic device 500a saves the user's selection and displays the user interface illustrated in FIG. 6H.

FIG. 6H illustrates the electronic device 500a displaying a payment user interface for confirming the hardware subscription in response to the input illustrated in FIG. 6G. In some embodiments, the payment user interface includes an option 626a to cancel the transaction, an option 626b to change payment methods for the transaction, an option 626c to change a shipping address for the electronic device associated with the hardware subscription, and an indication 626d of an expected delivery date for the electronic device associated with the hardware subscription. In some embodiments, the electronic device 500a automatically selects a payment method and shipping address saved to a payment application or API of the electronic device 500a without receiving user inputs selecting the payment method and shipping address. In some embodiments, in response to detecting selection of option 626b, the electronic device 500a displays a user interface for providing a different method of payment. In some embodiments, in response to detecting selection of option 626c, the electronic device 500a displays a user interface for providing a different shipping address. In some embodiments, in response to detecting an input directed to side button 601 of the electronic device 500a, the electronic device 500a enrolls in the hardware subscription with the selections made in FIGS. 6A through 6H.

It should be understood that the order in which the user interfaces illustrated in FIGS. 6A through 6H is one example of the order in which the user interfaces can be presented. The user interfaces illustrated in FIGS. 6A through 6H can be presented in a different order than the order in which they are described without departing from the scope of the disclosure. In some embodiments, in inputs illustrated in FIGS. 6A, 6B, and 6E through 6H cause the electronic device 500a to display different ones of the user interface illustrated in FIG. 6A through 6C and 6F through 6H than those expressly described herein, without departing from the scope of the disclosure.

FIGS. 6I through 6S illustrate an electronic device 500b displaying various user interfaces for managing a hardware subscription in which the user of the electronic device 500b is enrolled. In some embodiments, electronic device 500b is the electronic device associated with the hardware subscription configured in FIGS. 6A through 6H. In some embodiments, electronic device 500b illustrated in FIGS. 6I through 6S is a different electronic device from electronic device 500a illustrated in FIGS. 6A through 6H. In some embodiments, a single electronic device is able to display the user interfaces illustrated in FIGS. 6A through 6H and the user interfaces illustrated in FIGS. 6I through 6S. For example, electronic device 500a is able to display the user interfaces illustrated in FIGS. 6I through 6S and/or electronic device 500b is able to display the user interface illustrated in FIGS. 6A through 6H.

FIG. 6I illustrates the electronic device 500b displaying a subscription management user interface. In some embodiments, the electronic device 500b displays the subscription user interface in response to detecting an input directed to a subscription management user interface option displayed in a settings user interface. In some embodiments, the subscription management user interface includes a combination of hardware subscription(s) and software/digital content subscription(s). For example, in FIG. 6I, the subscription management user interface includes an representation 628a of a software subscription and representation 628b and 628c of hardware subscriptions.

In some embodiments, representation 628a corresponds to a subscription to software and/or a digital content service. As shown in FIG. 6I, representation 628a includes an image 630a associated with the content service and/or an application associated with the subscription, an indication 630b of the name of the service, and indication 630c of the tier of the subscription, and an indication 630d of the next billing date of the subscription and the subscription renewal fec.

In some embodiments, representation 628b corresponds to a hardware subscription to an electronic device in use by a user other than the user of electronic device 500b. For example, the electronic device associated with the subscription corresponding to representation 628b is associated with a user account different from the user account associated with the electronic device 500b. In some embodiments, the electronic device 500b displays representation 628b because the user of the electronic device 500b is associated with the subscription (e.g., by setting up and/or paying for the subscription). Additionally or alternatively, in some embodiments, the electronic device 500b displays representation 628b because the user of the electronic device accessed by the subscription is in a family and/or corporate group that the user of electronic device 500b also belongs to. For example, the user of electronic device 500b is a parent/adult/other administrator in a family group in which the user of the electronic device accessed by the subscription is a child/non-administrator. As another example, the user of electronic device 500b is an administrator in a corporate group in which the user of the electronic device accessed by the subscription is a non-administrator. As shown in FIG. 6I, the representation 628b includes an image 630e of the electronic device associated with the hardware subscription, an indication 630f of the name of the electronic device associated with the hardware subscription, and indication 630g of the model of the electronic device associated with the hardware subscription, and an indication 630h of the next billing date of the subscription and the subscription renewal fec.

In some embodiments, representation 628c corresponds to a hardware subscription to an electronic device in use the user of electronic device 500b. For example, electronic device 500b is the electronic device associated with the subscription corresponding to representation 628c. As another example, the electronic device associated with the hardware subscription corresponding to representation 628c is an electronic device different from electronic device 500b that is associated with the same user account as the user account with which electronic device 500b is associated. As shown in FIG. 6I, the representation 628c includes an image 630i of the electronic device associated with the hardware subscription, an indication 630j of the name of the electronic device associated with the hardware subscription, and indication 630k of the model of the electronic device associated with the hardware subscription, and an indication 630l of the next billing date of the subscription and the subscription renewal fec.

As shown in FIG. 6I, the electronic device 500b detects selection (e.g., by contact 603i) of the representation 628a of the software/digital content service subscription. In some embodiments, in response to receiving the input illustrated in FIG. 6I, the electronic device 500b displays the subscription management user interface illustrated in FIG. 6J.

FIG. 6J illustrates an example of the electronic device 500b displaying a subscription management user interface in response to the input illustrated in FIG. 6I. In some embodiments, the subscription management user interface is associated with the subscription corresponding to representation 628a. In some embodiments, the subscription management user interface includes information about the respective subscription without including information about other subscriptions to which the user account of electronic device 500b is subscribed.

As shown in FIG. 6J, the subscription management user interface includes the representation 628a of the software/content service subscription, options 632a through 632c for changing the tier of the subscription to which the user of the electronic device 500b is subscribed, an option 634 to cancel the subscription, and text 636 indicating the terms of cancellation. The electronic device 500b optionally displays option 632c with a check mark to indicate that option 632c corresponds to the tier of the subscription to which the user of electronic device 500b is subscribed. As shown in FIG. 6J, the electronic device 500b detects selection (e.g., by contact 603i) of option 632b corresponding to a tier of the subscription that is different from the tier of the subscription to which the user of the electronic device 500b is currently subscribed. In response to the input shown in FIG. 6J, the electronic device 500b changes the tier of the subscription to which the user of the electronic device 500b is subscribed. In some embodiments, after the electronic device 500b changes tier of the subscription to which the user is subscribed, the electronic device 500b updates the representation 628a of the subscription to indicate the new subscription tier.

FIG. 6K illustrates an example of the electronic device 500b displaying the subscription management user interface updated to indicate the change in subscription tier of the software/content service subscription associated with representation 628a. In some embodiments, the subscription management user interface illustrated in FIG. 6K is the same as the subscription management user interface illustrated in FIG. 6I, except representation 628a is updated to include an indication 630q of the new subscription tier selected in FIG. 6J. As shown in FIG. 6K, the electronic device 500b detects selection (e.g., by contact 603k) of the representation 628c of the hardware subscription associated with the electronic device associated with the same user account as the user account of electronic device 500b. In response to the input illustrated in FIG. 6K, the electronic device 500b displays the hardware subscription management user interface illustrated in FIG. 6L.

FIG. 6L illustrates the electronic device 500b displaying a hardware subscription user interface in response to the user input illustrated in FIG. 6K. In some embodiments, the hardware subscription user interface includes information and options associated with the hardware subscription to an electronic device associated with the same user account as the user account of electronic device 500b. In some embodiments, the hardware subscription user interface does not include information and options associated with other subscriptions.

As shown in FIG. 6L, the hardware subscription user interface includes a representation 638 of a recommended software/content services subscription. The representation 638 includes an image 631a associated with the recommended subscription, an indication 631b of the name of the recommended subscription, an option 631c to cease display of representation 638, and text 631d describing the recommended subscription. In some embodiments, the recommended subscription is a subscription to a bundle of services, such as a music subscription, a video content subscription, a games subscription, a cloud-based storage subscription, a workout video subscription, and/or a news subscription.

In some embodiments, the hardware subscription user interface further includes the representation 628c of the subscription described in more detail above with reference to FIG. 6I, a user interface element 640 associated with the warranty plan included in the hardware subscription, and an option 644a to initiate a process to upgrade the electronic device of the hardware subscription. In some embodiments, the user interface element 640 associated with the warranty plan included in the hardware subscription includes options 641a through 641c for changing the type of warranty plan coverage. As shown in FIG. 6L, option 641b is selected because option 641b is associated with the warranty plan included in the hardware subscription. In some embodiments, in response to detecting selection of option 641a or option 641c, the electronic device 500b updates the warranty plan of the hardware subscription to be the plan associated with the respective selected option. In some embodiments, in response to detecting selection of option 644a, the electronic device 500b initiates a process to upgrade the electronic device associated with the hardware subscription, as described in more detail below with reference to FIGS. 6M-6N.

As shown in FIG. 6L, the electronic device 500b detects a scrolling input (e.g., by contact 603L) directed to the hardware subscription user interface. In response to the input illustrated in FIG. 6L, the electronic device 500b scrolls the hardware subscription user interface as shown in FIG. 6M.

FIG. 6M illustrates an example of the electronic device 500b displaying the hardware subscription user interface in response to the scrolling input illustrated in FIG. 6L. As shown in FIG. 6M, the hardware subscription user interface further includes text 644b indicating the current terms of upgrading the electronic device associated with the hardware subscription, an option 644c to view the transaction history of the subscription, and option 644d to display the support user interface illustrated in FIG. 6O, an option 644e to cancel the subscription, and text 644f indicating the current terms for canceling the hardware subscription. In some situations, the electronic device associated with the hardware subscription can be upgraded for a fec. As shown In FIG. 6M, the text 644b indicates a date on which the hardware subscription will be eligible for an upgrade and the fee to upgrade the device today. In some situations, the subscription can be canceled for a fec. In FIG. 6M, text 644f indicates that fees will apply to cancel the subscription today and a date on which cancellation will be free. In some embodiments, the date on which an upgrade is available for free is the same as the date on which cancellation is available for free. In some embodiments, the date on which an upgrade is available for free is different from and earlier than the date on which cancellation is available for free. In some embodiments, the date on which an upgrade is available for free is different from and later than the date on which cancellation is available for free.

FIG. 6N illustrates an example of the electronic device 500b displaying the hardware subscription user interface when there is a free upgrade available for the hardware subscription. As shown in FIG. 6N, the hardware subscription user interface includes an indication 644g that there is a free upgrade available for the hardware subscription. In some embodiments, if there is a fee to cancel the subscription, the electronic device 500b displays text 644f in the hardware subscription user interface. In some embodiments, if free cancellation is available, the electronic device 500b displays text that indicates that free cancellation is available.

As shown in FIG. 6N, the electronic device 500b detects selection (e.g., by contact 603n) of the option 644d to display the support user interface. In some embodiments, in response to the input illustrated in FIG. 6N, the electronic device 500b displays the support user interface in FIG. 6O.

FIG. 6O illustrates an example of the electronic device 500b displaying a support user interface in response to the user input illustrated in FIG. 6O. In some embodiments, the support user interface includes an option 646a to update information associated with the hardware subscription, such as billing information and/or user information; an option 626b to contact a billing support department; and option 626c to initiate a repair request; and option 646d to report theft or loss of the device associated with the hardware subscription; an option 626e to view the lease agreement of the hardware subscription; and an option 626f to live chat with customer service for technical support and/or questions about the hardware subscription.

In some embodiments, in response to detecting selection of the option 646a to update the information, the electronic device 500b displays a user interface including text entry field(s) with information associated with the hardware subscription. In some embodiments, the electronic device 500b updates the information in response to detecting a sequence of inputs updating the text in the text entry field(s).

In some embodiments, in response to detecting selection of the option 646b to receive billing support, the electronic device 500b displays a user interface with information for contacting a billing support department associated with the hardware subscription, such as a user interface that includes selectable options to initiate a phone call, e-mail, chat session, or appointment with a billing support specialist.

In some embodiments, in response to detecting selection of the option 646c to make a repair request, the electronic device 500b displays a repair request user interface. In some embodiments, if the hardware subscription includes a warranty plan that covers repairs, a portion of the repair cost is waived. In some embodiments, if the hardware subscription does not include a warranty plan that covers repairs, the user pays for the repair. In some embodiments, the repair request user interface includes information about repairs, options to contact a repairs department for more information, and/or options to arrange an appointment at a store or repair business to bring the device in for a repair.

In some embodiments, in response to detecting selection of the option 646d to report loss or theft of the electronic device associated with the hardware subscription, the electronic device 500b displays a user interface for reporting loss or theft of the device associated with the hardware subscription. In some embodiments, if the hardware subscription includes a warranty plan that includes coverage for loss and/or theft, at least a portion of the replacement cost of the electronic device is covered by the warranty plan. In some embodiments, if the hardware subscription does not include a warranty plan that covers loss and/or theft, the user is responsible for covering the replacement cost of the device associated with the warranty plan.

In some embodiments, in response to detecting selection of the option 646e to view the lease agreement for the hardware subscription, the electronic device 500b displays the lease agreement for the hardware subscription. In some embodiments, in response to detecting selection of the option 646f to chat with a specialist, the electronic device 500b displays a chat user interface for a conversation with a support specialist.

In some embodiments, when there is a free upgrade available for the electronic device of the hardware subscription, the electronic device 500b displays indications of the available upgrade in the subscription management user interface and/or the settings user interface.

FIG. 6P illustrates an example of the electronic device 500b displaying the subscription management user interface including an indication 648 that a free upgrade is available for the electronic device of the hardware subscription. In some embodiments, the subscription management user interface includes elements that are the same as or similar to elements described above with reference to FIGS. 61 and/or 6K. In some embodiments, because a free upgrade is available for the electronic device of the hardware subscription, the subscription management user interface further includes an indication 648 that the free upgrade is available. As shown in FIG. 6P, the indication 648 includes a selectable option 650 that, when selected, causes the electronic device 500b to initiate a process to upgrade the electronic device of the hardware subscription. For example, the process to upgrade the electronic device of the hardware subscription includes displaying one or more user interfaces similar to the user interfaces of FIGS. 6A-6H to allow the user to select various options for the upgraded device, such as model, color, carrier, storage, warranty plan, and whether the current device and upgraded device should be exchanged in person at a store or by mail.

FIG. 6Q illustrates an example of the electronic device 500b displaying a settings user interface. As shown in FIG. 6Q, the settings user interface includes an option 652a to view/change settings related to a user account of the electronic device 500b, an option 652b to view/change settings related to a family group of user accounts including the user account of the electronic device 500b, the indication 648 that an upgrade is available for the electronic device of the hardware subscription, an option 654a to view/change settings related to airplane mode of the electronic device 500b, an option 654b to view/change settings related to a Wi-Fi connection of the electronic device 500b, an option 654c to view/change settings related to a Bluetooth connection of the electronic device 500b, an option 654d to view/change settings related to cellular service of the electronic device 500b, and an option 654e to view/change settings related to a personal hotspot of the electronic device 500b. In some embodiments, the indication 648 is the same as the indication described above with reference to FIG. 6P. In some embodiments, in response to detecting an input to scroll the settings user interface, the electronic device 500b displays additional options for viewing and/or changing other settings of the electronic device 500b.

In some embodiments, if the user cancels the hardware subscription, the electronic device 500b displays an indication of the canceled hardware subscription in the subscription management user interface in a section for canceled subscriptions. FIG. 6R illustrates an example of the electronic device 500b displaying a portion of the user interface for managing the hardware subscription that includes the option 644e to cancel the hardware subscription. As shown in FIG. 6R, the electronic device 500b detects selection (e.g., by contact 603r) of the option 644c to cancel the hardware subscription. In some embodiments, in response to detecting the input in FIG. 6R, the electronic device 500b initiates a process to cancel the hardware subscription, including displaying a user interface for the user to provide payment information to pay a cancellation fee if one applies and a user interface for selecting whether the electronic device of the hardware subscription will be returned in-person to a store or by mail.

FIG. 6S illustrates an example of the electronic device 500b displaying the subscription management user interface after the user canceled the hardware subscription. As shown in FIG. 6S, the representation 628c of the hardware subscription is displayed in a portion of the user interface for canceled subscriptions and includes an indication 630l of the date by which the electronic device of the hardware subscription must be returned. In some embodiments, the electronic device 500b maintains display of the other representations 628a and 628b of other subscriptions in the portion of the subscription management user interface of active subscriptions because the other subscriptions were not cancelled.

In some embodiments, it is possible for a first user to configure and pay for a hardware subscription for an electronic device to be used by a second user. For example, schools may subscribe to electronic devices for use by students; parents may subscribe to electronic devices for use by their children; and/or organizations may subscribe to electronic device devices for use by volunteers and/or employees. Referring to FIG. 6I, the electronic device 500b displays a representation 628b of a hardware subscription to access a smartphone used by another user, for example. In some embodiments, in response to detecting selection of the representation 628b, the electronic device 500b would display a subscription management user interface for the hardware subscription for the electronic device used by another user with the same and/or similar elements as the elements of the subscription management user interface illustrated in FIGS. 6L-6M. In some embodiments, the electronic device associated with the hardware subscription managed by a user other than the user of the electronic device displays a subscription management user interface for the hardware subscription that includes fewer elements than the elements displayed by the electronic device of the user that manages the hardware subscription.

For example, FIG. 6T illustrates electronic device 500c displaying a subscription management user interface. In some embodiments, electronic device 500c is an electronic device associated with a hardware subscription that is used by a user different from the user that manages the hardware subscription. In FIG. 6T, the electronic device 500c displays a representation 628d of the hardware subscription associated with the electronic device 500c in the subscription management user interface. For example, the representation 628d of the hardware subscription includes an image 630m associated with the hardware subscription, an indication 630n of the nickname of the electronic device 500c, an indication 6300 of the model of the electronic device 500c, and an indication 630p of the billing date and subscription cost of the hardware subscription. In some embodiments, if the user of the electronic device 500c was subscribed to one or more additional subscriptions, representations of the subscriptions would also be displayed in the subscription management user interface. As shown in FIG. 6T, the electronic device 500c detects selection (e.g., by contact 603t) of the representation 628d of the hardware subscription. In response to the input illustrated in FIG. 6T, the electronic device 500c displays the subscription management user interface illustrated in FIG. 6U.

FIG. 6U illustrates an example of the electronic device 500c displaying subscription management user interface for the hardware subscription. As shown in FIG. 6U, the subscription management user interface includes the representation 638 of a recommended software/content service subscription, the representation 628d of the hardware subscription, and a support option 644h. In some embodiments, the representation 638 of the recommended software/content service subscription includes the same or similar elements as the representation 638 described above with reference to FIG. 6L. In some embodiments, the representation 628d of the hardware subscription includes the same or similar elements as the representation 628d described above with reference to FIG. 6T. In some embodiments, in response to detecting selection of the support option 644h, the electronic device 500c displays a support user interface that is the same as or similar to the support user interface in FIG. 6O. In some embodiments, the subscription management user interface displayed by electronic device 500c in FIG. 6U excludes one or more elements included in the subscription management user interface displayed by electronic device 500b in FIGS. 6L-6M, such as one or more of the warranty plan user interface element 640, the upgrade option 644a, the transaction history option 644c, and the cancel subscription option 644c.

FIG. 7 is a flow diagram illustrating a method of managing hardware subscriptions in accordance with some embodiments of the disclosure. The method 700 is optionally performed at an electronic device such as device 100, device 300, device 500a, 500b, and/or 500c as described above with reference to FIGS. 1A-1B, 2-3, 4A-4B and 5A-5H. Some operations in method 700 are, optionally combined and/or order of some operations is, optionally, changed.

As described below, the method 700 provides ways in which an electronic device manages hardware subscriptions. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device (e.g., 500a, 500b, and/or 500c) in communication with a display generation component and one or more input devices. In some embodiments, the electronic device is a mobile device (e.g., a tablet, a smartphone, a media player, or a wearable device) including wired and/or wireless communication circuitry. The one or more input devices optionally includes a mouse (e.g., external), a trackpad (optionally integrated or external), a touchpad (optionally integrated or external), remote control device (e.g., external), another mobile device (e.g., separate from the electronic device), a handheld device (e.g., external), a controller (e.g., external), and/or a touch screen. a computer including. The display generation component is optionally a display integrated with the electronic device (optionally a touch screen display), external display such as a monitor, projector, television, or a hardware component (optionally integrated or external) for projecting a user interface or causing a user interface to be visible to one or more users. In some embodiments, the display is integrated with the electronic device as a touch screen display that includes a touch sensitive surface. The electronic device is optionally a set-top box in communication with a display and a remote control device or a computer including one or more of a keyboard, mouse, trackpad, and touch screen, and optionally in communication with a display.

In some embodiments, the electronic device (e.g., 500b) displays (702), via the display generation component, a subscription management user interface that concurrently includes an indication of a first subscription associated with a user account of the electronic device, wherein the first subscription grants the user account access to a first service, and an indication of a second subscription associated with the user account of the electronic device, wherein the second subscription grants access to a hardware product, such as the subscription management user interface of FIG. 6I, including indications 628a and 628b. In some embodiments, the user account is a user account for accessing purchased and subscription software, communication applications, and saving device settings. In some embodiments, the first subscription grants access to an application running on the electronic device. In some embodiments, the first subscription grants access to (optionally digital) content, such as music, video content, and/or articles. In some embodiments, the first subscription grants access to a service, such as cloud-based storage. In some embodiments, the second subscription grants access to the electronic device. In some embodiments, the second subscription grants access to a second device different from the electronic device. In some embodiments, the second subscription is to a hardware leasing program that grants access to the hardware product. In some embodiments, the indication of the first subscription and the indication of the second subscription include information about the first or second subscription, respectively, as described in more detail below. In some embodiments, the subscription management user interface includes indications of subscriptions that the user account is or was previously subscribed to. In some embodiments, prior to the user account subscribing to a respective subscription, the subscription management user interface does not include an indication of the respective subscription. In some embodiments, in response to the user subscribing to the respective subscription, the electronic device displays the indication of the respective subscription in the subscription management user interface. For example, while the subscription is active, the electronic device displays the indication of the respective subscription in a portion of the subscription management user interface for indications of active subscriptions. In some embodiments, once the respective subscription lapses or is canceled, the electronic device displays the indication of the subscription in a portion of the subscription management user interface for indications of inactive subscriptions. In some embodiments, once the respective subscription lapses or is canceled, the electronic device ceases to display the indication of the respective subscription.

In some embodiments, while displaying the subscription management user interface, the electronic device (e.g., 500b) receives (704), via the one or more input devices, one or more inputs corresponding to a request to revise the first subscription or the second subscription, such as contact 603i in FIG. 6I.

In some embodiments, in response to receiving the one or more inputs (706), such as contact 603i in FIG. 6I, in accordance with a determination that the one or more inputs includes an input directed to the indication of the first subscription, the electronic device (e.g., 500a, 500b, and/or 500c) initiates (708) a process to revise the first subscription, such as displaying the user interface in FIG. 6J. In some embodiments, the input includes selection of the indication of the first subscription. In some embodiments, in response to detecting the input directed to the indication of the first subscription, the electronic device displays a user interface including additional details about the first subscription and a selectable option that, when selected, causes the electronic device to initiate the process to modify the first subscription. In some embodiments, modifying the first subscription includes cancelling the first subscription, changing a renewal term of the first subscription, and/or changing subscription terms and/or tier. In some embodiments, in response to a sequence of inputs revising the first subscription, the electronic device updates the subscription management user interface to reflect the changes made to the first subscription.

In some embodiments, in response to receiving the one or more inputs (706), such as contact 603k in FIG. 6K, in accordance with a determination that the one or more inputs includes an input directed to the indication of the second subscription, the electronic device (e.g., 500a, 500b, or 500c) initiates (710) a process to revise the second subscription, such as displaying the user interface in FIG. 6L. In some embodiments, the input includes selection of the indication of the second subscription. In some embodiments, in response to detecting the input directed to the indication of the second subscription, the electronic device displays a user interface including additional details about the second subscription and a selectable option that, when selected, causes the electronic device to initiate the process to modify the second subscription. In some embodiments, modifying the second subscription includes cancelling the second subscription, and/or changing subscription terms, such as changing a warranty plan associated with the hardware product. In some embodiments, in response to a sequence of inputs revising the second subscription, the electronic device updates the subscription management user interface to reflect the changes made to the second subscription. Displaying indications of hardware and software subscriptions together in the subscription management user interface enhances user interactions with the electronic device by reducing the number of inputs needed to review a plurality of different types of subscriptions associated with the user account of the electronic device.

In some embodiments, the electronic device (e.g., 500a) displays, via the display generation component, a hardware subscription user interface that includes an indication of a recommended hardware product having a respective configuration, such as indication 604b in FIG. 6A. In some embodiments, the indication of the recommended hardware product includes an indication of the respective configuration of the hardware product, including one or more of the characteristics described below and/or model number, color, and/or connectivity (e.g., cellular, GPS, and/or Wi-Fi capabilities) of the recommended device. In some embodiments, the hardware subscription user interface further includes options for trading in the electronic device and/or a different electronic device as at least partial payment towards the hardware subscription, options for fulfilment of the hardware product accessed through the hardware subscription (e.g., shipping or in-store pickup), and/or carrier (e.g., cellular service provider) options.

In some embodiments, the electronic device (e.g., 500a) displays, via the display generation component, a hardware subscription user interface that includes a selectable option that, when selected, causes the electronic device to initiate a process to subscribe the user account to a hardware subscription that grants access to the recommended hardware product, such as option 602b in FIG. 6A. In some embodiments, the process to subscribe the user account to the hardware subscription includes displaying an indication of the configuration of the hardware product to which access is granted through the hardware subscription. In some embodiments, the process to subscribe the user account to the hardware subscription includes collecting and authorizing payment information for payment for access to the hardware subscription. In some embodiments, the process to subscribe the user account to the hardware subscription includes activating the subscription, including initiating payment for access to the hardware product and/or fulfilment of the hardware product. In some embodiments, the process to subscribe the user account to the hardware subscription includes displaying options to purchase recommended accessories (e.g., protective cases, charging accessories, input and/or output devices) for the hardware product accessed using the hardware subscription.

In some embodiments, in accordance with a determination that the electronic device has a first configuration, the recommended hardware product has a second configuration based on the first configuration of the electronic device, such as recommending option 604b in FIG. 6A based on a device in use by the user. In some embodiments, the first configuration includes values for one or more characteristics and the values for the one or more characteristics included in the second configuration are the same as or similar to the values for the one or more characteristics included in the first configuration, respectively. In some embodiments, the characteristics include the characteristics listed above and/or the characteristics described in more detail below. For example, the model of the second configuration is a model that is the same as or similar to the model of the electronic device. As another example, the color of the second configuration is the same as or similar to the color of the electronic device. As another example, the connectivity of the second configuration is the same as or similar to the connectivity of the electronic device.

In some embodiments, in accordance with a determination that the electronic device has a third configuration different from the first configuration, the recommended hardware product has a fourth configuration different from the second configuration and based on the third configuration of the electronic device, such as recommending option 604a or 604c in FIG. 6A if the device used by the user had a different configuration. In some embodiments, the third configuration includes values for one or more characteristics and the values for the one or more characteristics included in the fourth configuration are the same as or similar to the values for the one or more characteristics included in the third configuration, respectively. In some embodiments, the characteristics include the characteristics listed above and/or the characteristics described in more detail below. For example, the model of the fourth configuration is a model that is the same as or similar to the model of the electronic device. As another example, the color of the fourth configuration is the same as or similar to the color of the electronic device. As another example, the connectivity of the fourth configuration is the same as or similar to the connectivity of the electronic device. Recommending a hardware product for the hardware subscription the has a configuration similar to the configuration of the electronic device enhances user interactions with the electronic device by reducing the time and inputs needed to subscribe to access to a hardware product that meets user needs.

In some embodiments, in accordance with a determination that a first amount of storage is in use on the electronic device, the respective configuration includes a second amount of storage based on the first amount of storage, such as recommending option 612b in FIG. 6C based on storage usage of the user. In some embodiments, the second amount of storage is at least as much storage as the first amount of storage. In some embodiments, the second amount of storage is greater than the first amount of storage by a predetermined percentage (e.g., 5, 10, 15, 20, 30, or 50 percent) or a predetermined amount (e.g., 1, 2, 4, 12, 24, 48, 56, or 128 gigabytes). In some embodiments, the second amount of storage is based on the amount of storage in use on the electronic device and an amount of remote (e.g., cloud) storage in use, as described in more details below. In some embodiments, the amount of storage included in the respective configuration is an amount of storage included in the hardware of the hardware product. In some embodiments, the amount of storage included in the respective configuration includes remote (e.g., cloud) storage on a remote server configured to communicate with the hardware product.

In some embodiments, in accordance with a determination that a third amount of storage different from the first amount of storage is in use on the electronic device, the respective configuration includes a fourth amount of storage different from the second amount of storage based on the third amount of storage, such as recommending option 612a or 612c in FIG. 6C if the storage usage of the user were different. In some embodiments, the fourth amount of storage is at least as much storage as the third amount of storage. In some embodiments, the fourth amount of storage is greater than the third amount of storage by a predetermined percentage or a predetermined amount, as described above. In some embodiments, the fourth amount of storage is based on the amount of storage in use on the electronic device and an amount of remote (e.g., cloud) storage in use, as described in more details below. Recommending a subscription to a hardware product that includes an amount of storage based on the amount of storage in use on the electronic device enhances user interactions with the electronic device by reducing the inputs needed to select a hardware product with sufficient storage for the user's storage usage.

In some embodiments, in accordance with the first configuration including a first warranty plan, the second configuration includes a second warranty plan based on the first warranty plan, such as recommending option 616b in FIG. 6E based on the warranty plan in use by the user. In some embodiments, the second warranty plan is the same as the first warranty plan. In some embodiments, the second warranty plan has a coverage period and/or coverage type (e.g., accidental damage, loss, and/or theft to the hardware product) that is the same as the coverage period and/or coverage type of the first warranty plan. In some embodiments, the second warranty plan is different from the first warranty plan. For example, the first warranty plan may no longer be offered, or may not be available for the hardware product. In some embodiments, if the first warranty plan is no longer offered, the electronic device selects the second warranty plan that is most similar to the first warranty plan among warranty plans that are available for the hardware product.

In some embodiments, in accordance with the third configuration including a third warranty plan different from the first warranty plan, the fourth configuration includes a fourth warranty plan different from the second warranty plan and based on the third warranty plan, such as recommending option 616a or option 616c in FIG. 6E if the warranty plan in use by the user were different. In some embodiments, the fourth warranty plan is the same as the third warranty plan. In some embodiments, the fourth warranty plan has a coverage period and/or coverage type (e.g., accidental damage, loss, and/or theft to the hardware product) that is the same as the coverage period and/or coverage type of the third warranty plan. In some embodiments, the fourth warranty plan is different from the third warranty plan. For example, the third warranty plan may no longer be offered, or may not be available for the hardware product. In some embodiments, if the third warranty plan is no longer offered, the electronic device selects the fourth warranty plan that is most similar to the third warranty plan among warranty plans that are available for the hardware product. Selecting a warranty plan for the hardware product based on the warranty plan of the electronic device enhances user interactions with the electronic device by reducing the time and inputs needed to subscribe to a hardware product covered by a warranty plan that is consistent with the user's previous warranty plan usage/preferences.

In some embodiments, in accordance with a determination that the user account is using a first amount of remote storage, the respective configuration includes a second amount of storage based on the first amount of remote storage, such as recommending option 612b in FIG. 6C based on a remote storage account of the user. In some embodiments, the second amount of storage is at least as much storage as the first amount of remote storage. In some embodiments, the second amount of storage is greater than the first amount of remote storage by a predetermined percentage (e.g., 5, 10, 15, 20, 30, or 50 percent) or a predetermined amount (e.g., 1, 2, 4, 12, 24, 48, 56, or 128 gigabytes). In some embodiments, the second amount of storage is within (e.g., greater than or less than) a threshold percentage (e.g., 5, 10, 15, 20, 30, or 50 percent) or a predetermined amount (e.g., 1, 2, 4, 12, 24, 48, 56, or 128 gigabytes) of the first amount of remote storage. In some embodiments, the second amount of storage is based on the amount of storage in use on the electronic device and an amount of remote storage in use, as described in more details above. In some embodiments, the amount of storage included in the respective configuration is an amount of storage included in the hardware of the hardware product. In some embodiments, the amount of storage included in the respective configuration includes remote storage on a remote server configured to communicate with the hardware product. In some embodiments, the user account accesses the remote storage through a subscription to a remote storage service. In some embodiments, the electronic device displays an indication of the remote storage service subscription in the subscription management user interface described above. In some embodiments, the remote storage is storage on another electronic device (e.g., a server) other than the electronic device that is in communication with the electronic device through a network connection. In some embodiments, the network connection is encrypted.

In some embodiments, in accordance with a determination that the user account is using a third amount of remote storage different from the first amount of remote storage, the respective configuration includes a fourth amount of storage different from the second amount of storage based on the third amount of remote storage, such as recommending option 612a or 612c in FIG. 6C if the remote storage account of the user were different. In some embodiments, the fourth amount of storage is at least as much storage as the third amount of remote storage. In some embodiments, the fourth amount of storage is greater than the third amount of remote storage by a predetermined percentage or predetermined amount, as described above. In some embodiments, the fourth amount of storage is within (e.g., greater than or less than) a threshold percentage or a predetermined amount of the third amount of remote storage. Recommending a subscription to a hardware product that includes an amount of storage based on the amount of remote storage in use by the user account enhances user interactions with the electronic device by reducing the inputs needed to select a hardware product with sufficient storage for the user's storage usage.

In some embodiments, the hardware subscription user interface further includes, in accordance with the determination that the electronic device has the first configuration, an indication of a reason why the second configuration is recommended for the hardware product based on the first configuration, such as indication 614c in option 612b in FIG. 6C. In some embodiments, the indication includes indication(s) of one or more characteristics of the second configuration that are the same as, similar to, or otherwise based on one or more characteristics of the first configuration. For example, the hardware subscription user interface includes an indication that the second configuration includes a second amount of storage on the hardware device because a first amount of storage is in use on the electronic device and/or in use as remote storage accessed through the user account. As another example, the hardware subscription user interface includes an indication that the second configuration includes a second warranty plan that has one or more characteristics in common with a first warranty plan (e.g., currently or previously) associated with the electronic device. In some embodiments, if one or more configurations are not recommended for the hardware product, the hardware subscription user interface includes one or more indications explaining why those configurations are not recommended. For example, the hardware subscription user interface includes an indication that a respective amount of storage that is less than the amount of storage in use on the electronic device is not recommended because the user is currently using more storage than the respective amount of storage. In some embodiments, the electronic device displays the indication of why a respective configuration is not recommended in response to receiving a user input selecting the respective configuration for the hardware product for the second subscription and optionally does not display the indication prior to receiving the input.

In some embodiments, the hardware subscription user interface further includes in accordance with the determination that the electronic device has the third configuration, an indication of a reason why the fourth configuration is recommended for the hardware product based on the third configuration, such as displaying an indication similar to indication 614c in FIG. 6C in option 612a or option 612c. In some embodiments, the indication includes indication(s) of one or more characteristics of the fourth configuration that are the same as, similar to, or otherwise based on one or more characteristics of the third configuration. For example, the hardware subscription user interface includes an indication that the fourth configuration includes a fourth amount of storage on the hardware device because a third amount of storage is in use on the electronic device and/or in use as remote storage accessed through the user account. As another example, the hardware subscription user interface includes an indication that the fourth configuration includes a fourth warranty plan that has one or more characteristics in common with a third warranty plan (e.g., currently or previously) associated with the electronic device. Displaying indications that explain why the respective configuration is recommended for the hardware product enhances user interactions with the electronic device by reducing the amount of time needed to select a suitable hardware product for the hardware subscription based on current and/or previous device usage and/or configuration.

In some embodiments, while displaying the indication of the second subscription that grants access to the hardware product in the subscription management user interface, such as indication 628c in FIG. 6P, in accordance with a determination that a (e.g., free) device upgrade is available for the second subscription, the electronic device (e.g., 500b) displays, via the display generation component, an indication that the device upgrade is available in the subscription management user interface, such as indication 648 in FIG. 6P. In some embodiments, the device upgrade is a free device upgrade that enables the user to trade in the hardware product for a new hardware product on a subscription basis without additional fees (e.g., beyond subscription fees for the second subscription). In some embodiments, the indication indicates that the device upgrade is free. In some embodiments, the indication includes an indication of the electronic device to be traded in or upgraded. In some embodiments, the indication includes an indication of a new hardware product the user will be able to upgrade to. In some embodiments, the free device upgrade becomes available once the subscription has been activated and paid for a predetermined amount of time (e.g., 6, 12, 18, 24, 30, or 36 months) without receiving an upgrade. In some embodiments, the indication of the upgrade is displayed as part of the indication of the second subscription. In some embodiments, the indication of the upgrade is displayed proximate to the indication of the second subscription. In some embodiments, the indication of the upgrade is displayed at a location in the subscription management user interface independent from the location of the indication of the second subscription in the subscription management user interface, such as being displayed at a predetermined location (e.g., the top of the subscription management user interface). In some embodiments, in response to detecting selection of the indication, the electronic device initiates a process for upgrading the hardware product. In some embodiments, upgrading the hardware product includes displaying a user interface for selecting the configuration and delivery method of a new hardware product and method (e.g., shipping or in-person dropoff) of returning the hardware product being upgraded. In some embodiments, upgrading the hardware product includes extending and/or modifying the second subscription to access the upgraded hardware product using the second subscription.

In some embodiments, while displaying the indication of the second subscription that grants access to the hardware product in the subscription management user interface, such as indication 628c in FIG. 6P, in accordance with a determination that the (e.g., free) device upgrade is not available for the second subscription, the electronic device (e.g., 500b) forgoes displaying the indication in the subscription management user interface, such as omitting indication 648 in FIG. 6P. In some embodiments, if the free upgrade is not available, the electronic device forgoes display of an indication related to a hardware upgrade. In some embodiments, if the free upgrade is not available, the electronic device displays an indication with information about a paid upgrade, as described in more detail below. Concurrently displaying the indication of the device upgrade with the indication of the second subscription that grants access to the hardware product enhances user interactions with the electronic device by reducing the number of inputs needed to view information and interact with settings related to the second subscription.

In some embodiments, while the user account is actively enrolled in the second subscription that grants access to the hardware product, the electronic device (e.g., 500b), via the display generation component, a settings user interface, such as the settings user interface in FIG. 6Q, that includes a selectable option that, when selected, causes the electronic device (e.g., 500b) to initiate a process to change a setting of the electronic device, such as selectable option 652a, 642b and/or selectable options 654a-654e in FIG. 6Q. In some embodiments, while the user account is actively enrolled in the second subscription, the user is entitled to use, access, and/or possess the hardware product. In some embodiments, active enrollment in a subscription requires payment of reoccurring renewal fees. In some embodiments, in response to detecting selection of the selectable option, the electronic device changes the setting of the electronic device. For example, the settings user interface is a subscriptions settings user interface and the option is an option for changing a setting related to subscriptions on the electronic device. In some embodiments, in response to detecting selection of the option, the electronic device navigates to a different page in the settings user interface, such as navigating to the subscriptions settings user interface or a different settings user interface in response to detecting selection of the selectable option. In some embodiments, navigating the settings user interface is included in the process to change a setting of the electronic device.

In some embodiments, while the user account is actively enrolled in the second subscription that grants access to the hardware product, the electronic device (e.g., 500b), via the display generation component, a settings user interface, such as the settings user interface in FIG. 6Q, that includes, in accordance with a determination that a (e.g., free) device upgrade is available for the second subscription, an indication that the device upgrade is available, such as indication 648 in FIG. 6Q, wherein in accordance with a determination that the (e.g., free) device upgrade is not available for the second subscription, the settings user interface does not include the indication in the subscription management user interface, such as omitting indication 648 in FIG. 6Q. In some embodiments, the indication that the device upgrade is available has one or more of the characteristics of the indication that the device upgrade is available described in more detail above. As described above, in some embodiments, in accordance with the determination that the free device upgrade is not available, the electronic device forgoes display of the indication. In some embodiments, as described in more detail below, if a free device upgrade is not available, if a paid upgrade is available, the electronic device displays an indication of the paid upgrade, as described in more detail below. In some embodiments, in response to detecting selection of the indication, the electronic device initiates a process for upgrading the hardware product. In some embodiments, upgrading the hardware product includes displaying a user interface for selecting the configuration and delivery method of a new hardware product and method (e.g., shipping or in-person dropoff) of returning the hardware product being upgraded. In some embodiments, upgrading the hardware product includes extending and/or modifying the second subscription to access the upgraded hardware product using the second subscription. Displaying the indication of the availability of the device upgrade in the settings user interface enhances user interactions with the electronic device by reducing the number of inputs needed to obtain the upgrade.

In some embodiments, displaying the subscription management user interface including the indication of the first subscription and the indication of the second subscription, such as the subscription management user interface in FIG. 6I, includes displaying, in the indication of the first subscription, an indication of a name of the first service of the first subscription, an indication of a tier of the first subscription, an indication of a next renewal date of the first subscription, and an indication of a renewal price of the first subscription, such as in indication 628a in FIG. 6I. In some embodiments, the name of the service of the first subscription includes the name of the provider of the first service. In some embodiments, the tier of the first subscription includes a level of access, usage, or features of the first subscription. For example, a tier of a remote storage subscription service indicates the amount of storage the first subscription entitles the user account to access. As another example, a tier of a content streaming service indicates the number of users able to access the streaming service, the resolution or quality of the content accessed via the first subscription to the streaming service, and/or whether or not the content is streamed with or without advertiser content. In some embodiments, the renewal date of the first subscription is a date through which the user account has access to the first subscription by paying the previous renewal fees or in a free trial period after which the user account must pay to renew the first subscription (e.g., by automatically being charged or by opting in to renew the first subscription) in order to continue to access the first subscription. In some embodiments, the renewal price is the amount of payment due on the renewal date to enable the user account to continue to access the first subscription after the renewal date.

In some embodiments, displaying the subscription management user interface including the indication of the first subscription and the indication of the second subscription, such as the subscription management user interface in FIG. 6I, includes displaying, in the indication of the second subscription, an indication of a nickname of the hardware product, an indication of a configuration of the hardware product, an indication of a next renewal date of the second subscription, and an indication of a renewal price of the second subscription, such as in indication 628c in FIG. 6I. In some embodiments, the nickname of the hardware product is text defined by a user (e.g., the user of the electronic device or the user of the hardware product) to aid in identifying the hardware product and distinguishing the hardware product from other electronic devices and/or hardware products used by the user. In some embodiments, the configuration of the hardware product includes the model name and/or number of the hardware product and/or one or more configuration characteristics described above. In some embodiments, the renewal date and renewal price of the second subscription are similar to those described above with reference to the first subscription, respectively. Displaying different indications within the indication of the first subscription and the indication of the second subscription enhances user interactions with the electronic device by providing the user with relevant information for different types (e.g., services vs. hardware access) of subscriptions.

In some embodiments, while displaying the subscription management user interface, the electronic device (e.g., 500b) receives, via the one or more input devices, an input corresponding to a request to view details about the second subscription that grants access to the hardware product, such as contact 603k in FIG. 6K. In some embodiments, receiving the input includes detecting selection of the indication of the second subscription. In some embodiments, receiving the input includes detecting a voice input, keyboard shortcut, or other input not directed to the indication of the second subscription.

In some embodiments, in response to receiving the input, the electronic device (e.g., 500b) displays, via the display generation component, a subscription details user interface for the second subscription that includes an indication of a device upgrade associated with the second subscription, such as indication 644b in FIG. 6M. In some embodiments, the subscription details user interface includes additional information about the second subscription, including the indications described above, and additional indications and options described below.

In some embodiments, in accordance with a determination that one or more criteria are satisfied, the indication of the device upgrade includes an indication that the user account is eligible for a no-cost device upgrade, such as indication 644g in FIG. 6N. In some embodiments, the one or more criteria include a criterion that is satisfied when the user has accessed the hardware product for a threshold amount of time under the second subscription, such as the threshold amount of time described above. In some embodiments, a no-cost upgrade includes receiving a new hardware product in exchange for the hardware product currently accessed through the second subscription with no upgrade fee. In some embodiments, the user will access the new hardware product through the second subscription or a similar hardware subscription that includes a renewal fec.

In some embodiments, in accordance with a determination that the one or more criteria are not satisfied, the indication of the device upgrade includes an indication of a price to upgrade the hardware product today and an indication of a date on which the user account will be eligible for the no-cost upgrade, such as indication 644b in FIG. 6M. In some embodiments, the cost of the hardware product upgrade depends on the amount of time remaining before the user has accessed the hardware product through the second subscription for the threshold period of time. In some embodiments, the upgrade fee reduces as more time since the user received the hardware product through the second subscription has passed. In some embodiments, if the user pays the price to upgrade the hardware, the user will be able to access new hardware through the second subscription or a similar a hardware subscription by paying a reoccurring subscription fec. Displaying information about upgrading the hardware accessed through the second subscription in the subscription details user interface enhances user interactions with the electronic device by reducing the number of inputs needed to manage the second subscription.

In some embodiments, while displaying the subscription management user interface, the electronic device (e.g., 500b) receives, via the one or more input devices, an input corresponding to a request to view details about the second subscription that grants access to the hardware product, such as contact 603k in FIG. 6K. In some embodiments, receiving the input includes detecting selection of the indication of the second subscription. In some embodiments, receiving the input includes detecting a voice input, keyboard shortcut, or other input not directed to the indication of the second subscription.

In some embodiments, in response to receiving the input corresponding to the request to view details about the second subscription, the electronic device (e.g., 500b) displays, via the display generation component, a subscription details user interface for the second subscription that includes an indication of a warranty plan associated with the second subscription, such as indication 640 in FIG. 6L. In some embodiments, the indication of the warranty plan incudes information about the warranty plan, such as the duration of coverage of the warranty plan, the type of coverage of the warranty plan as described above, and/or the portion of the subscription fees for the second subscription that go towards the warranty plan. In some embodiments, the warranty plan provides coverage for replacement and/or repair for the hardware product with terms defined by the warranty plan, such as in the event of damage, loss, or theft of the hardware product. In some embodiments, the coverage is partial and/or full financial coverage, such as a price reduction or reimbursement, for repair or replacement of the hardware product accessed through the second subscription. In some embodiments, the user account is able to enroll in the second subscription, which enables the user to access and use the hardware product but does not necessarily provide warranty coverage, independent from enrollment in the warranty plan. In some embodiments, similar warranty plans are available for hardware products not accessed through subscriptions, such as hardware products purchased by the user.

In some embodiments, while displaying the subscription details user interface including the indication of the warranty plan, the electronic device (e.g., 500b) receives, via the one or more input devices, a user input corresponding to selection of the indication of the warranty plan, such as an input directed to options 641a, 641b, or 641c in indication 640 in FIG. 6L.

In some embodiments, in response to receiving the user input corresponding to the selection of the indication of the warranty plan, such as an input directed to options 641a, 641b, or 641c in indication 640 in FIG. 6L, the electronic device (e.g., 500b) initiates a process to change the warranty plan associated with the second subscription. In some embodiments, changing the warranty plan includes one or more of changing the coverage period and/or the type(s) of coverage of the warranty plan. In some embodiments, changing the warranty plan associated with the second subscription changes the reoccurring renewal cost of the second subscription. Providing a way to change the warranty plan associated with the second subscription from the subscription details user interface enhances user interactions with the electronic device by enabling the user to make changes related to the second subscription quickly and efficiently with fewer inputs.

In some embodiments, while displaying the subscription management user interface, the electronic device (e.g., 500b) receives, via the one or more input devices, an input corresponding to a request to view details about the second subscription that grants access to the hardware product, such as contact 603k in FIG. 6K. In some embodiments, receiving the input includes detecting selection of the indication of the second subscription. In some embodiments, receiving the input includes detecting a voice input, keyboard shortcut, or other input not directed to the indication of the second subscription.

In some embodiments, in response to receiving the input corresponding to the request to view details about the second subscription, the electronic device (e.g., 500b) displays, via the display generation component, a subscription details user interface for the second subscription that includes a plurality of user interface elements related to the second subscription, including, in accordance with a determination that the user account is actively enrolled in the second subscription, a transaction history option that, when selected, causes the electronic device to display indications of transactions related to the second subscription, such as transaction history option 644c in FIG. 6M. In some embodiments, the indications of transactions related to the second subscription include indications of payments of the reoccurring renewal fees for access to the second subscription, indications of changes to the warranty plan associated with the second subscription, and/or indications of repair and/or replacement costs paid by the user for repairing and/or replacing the hardware product while subscribed to the second subscription.

In some embodiments, in response to receiving the input corresponding to the request to view details about the second subscription, the electronic device (e.g., 500b) displays, via the display generation component, a subscription details user interface for the second subscription that includes a plurality of user interface elements related to the second subscription, including, in accordance with a determination that the user account is actively enrolled in the second subscription, a support option that, when selected, causes the electronic device to initiate a process to get support related to the hardware product accessed through the second subscription, such as support option 644d in FIG. 6M. In some embodiments, initiating the process to get support related to the hardware product associated with the second subscription is described in more details below.

In some embodiments, in response to receiving the input corresponding to the request to view details about the second subscription, the electronic device (e.g., 500b) displays, via the display generation component, a subscription details user interface for the second subscription that includes a plurality of user interface elements related to the second subscription, including, in accordance with a determination that the user account is actively enrolled in the second subscription: a cancelation option that, when selected, causes the electronic device to initiate a process to cancel the second subscription, such as cancellation option 644c in FIG. 6M. In some embodiments, the process to cancel the second subscription includes paying applicable cancelation fees, if any, selecting a manner of returning the hardware product (e.g., via mail or in person at a store), and completing the return of the hardware product.

In some embodiments, in response to receiving the input corresponding to the request to view details about the second subscription, the electronic device (e.g., 500b) displays, via the display generation component, a subscription details user interface for the second subscription that includes a plurality of user interface elements related to the second subscription, including, in accordance with a determination that the user account is actively enrolled in the second subscription an indication of terms of canceling the second subscription, such as text 644f in FIG. 6M. In some embodiments, the indication of the terms of canceling the second subscription include information about a cancelation fee owed if the second subscription is canceled today, an indication of a date on which the second subscription will be eligible for free cancelation, and/or information about how to return the hardware product in the event the second subscription is canceled. Displaying the user interface elements related to the second subscription in the subscription details user interface enhances user interactions with the electronic device by reducing the inputs needed to view various information and make various changes related to the second subscription.

In some embodiments, displaying, via the display generation component, the subscription details user interface for the second subscription includes, in accordance with a determination that the access of the user account to the second subscription has been canceled, such as in FIG. 6S, displaying a subset of the plurality of user interface elements. In some embodiments, after the second subscription has been canceled, the second subscription is canceled or expired. In some embodiments, the second subscription is canceled upon cancelation of the subscription, but before the next renewal date of the second subscription passes without the user account renewing the second subscription. In some embodiments, once the renewal date of the second subscription passes without the user account renewing the second subscription, the second subscription is expired. In some embodiments, once the second subscription has been canceled, the subscription details user interface no longer includes one or more of the user interface elements described above, such as the support option, cancelation option, and/or indication of the terms of canceling the second subscription. Ceasing display of one or more user interface elements of the subscription details user interface for the second subscription after the second subscription is canceled enhances user interactions with the electronic device by maintaining access to relevant actions and information without including indications that are non-functional after the second subscription is canceled.

In some embodiments, while displaying the subscription management user interface, the electronic device (e.g., 500b) receives, via the one or more input devices, an input corresponding to a request to view details about the second subscription that grants access to the hardware product, such as contact 603k in FIG. 6K. In some embodiments, receiving the input includes detecting selection of the indication of the second subscription. In some embodiments, receiving the input includes detecting a voice input, keyboard shortcut, or other input not directed to the indication of the second subscription.

In some embodiments, in response to receiving the input corresponding to the request to view details about the second subscription, the electronic device (e.g., 500b) displays, via the display generation component, a subscription details user interface for the second subscription that includes a support option, such as support option 644d in FIG. 6M. In some embodiments, the subscription details user interface further includes one or more selectable options and/or user interface elements described above.

In some embodiments, while displaying the subscription details user interface for the second subscription, the electronic device (e.g., 500b) receives, via the one or more input devices, an input corresponding to selection of the support option, such as contact 603n in FIG. 6N.

In some embodiments, in response to receiving the input corresponding to the selection of the support option, the electronic device (e.g., 500b) displays, via the display generation component, a support menu that includes an assistance option that, when selected, causes the electronic device to initiate a process to receive assistance resolving a technical difficulty with the hardware product, such as option 646f in FIG. 6O. In some embodiments, the support menu is displayed at least partially (e.g., fully or partially) overlaid on the subscription details user interface. In some embodiments, the electronic device displays an animation of the support menu sliding over the subscription details user interface from an edge of the subscription details user interface, such as sliding up from the bottom edge. In some embodiments, initiating the process to receive assistance resolving the technical difficulty includes displaying an option to message a support specialist, make an appointment with a support specialist, access a support forum to post a question or read previous questions made by other users and their associated answers, and/or one or more options for viewing support articles, such as frequently asked questions and/or troubleshooting articles.

In some embodiments, in response to receiving the input corresponding to the selection of the support option, the electronic device (e.g., 500b) displays, via the display generation component, a support menu that includes an information option that, when selected, causes the electronic device to initiate a process to update the user information associated with the second subscription, such as option 646a in FIG. 6O. In some embodiments, the user information includes a name, address, phone number, e-mail address and/or other identifying and/or personal information related to the user of the hardware product or the user of the electronic device. In some embodiments, the user of the hardware product is the user of the electronic device. In some embodiments, the user of the hardware product and the user of the electronic device are different people.

In some embodiments, in response to receiving the input corresponding to the selection of the support option, the electronic device (e.g., 500b) displays, via the display generation component, a support menu that includes a billing option that, when selected, causes the electronic device to initiate a process to view or update billing information for the second subscription, such as option 646b in FIG. 6O. In some embodiments, the billing information includes a payment method, such as a bank account, credit card, or debit card. In some embodiments, the billing information includes a billing address associated with the payment method. In some embodiments, in response to detecting selection of the billing option, the electronic device displays an option to contact support to ask a question about billing concurrently with the billing information.

In some embodiments, in response to receiving the input corresponding to the selection of the support option, the electronic device (e.g., 500b) displays, via the display generation component, a support menu that includes a warranty claim option that, when selected, causes the electronic device to initiate a process to file a claim using a warranty plan associated with the second subscription, such as option 646c and/or 646d in FIG. 6O. In some embodiments, the warranty claim option initiates a process to schedule a repair covered by warranty for the hardware product. In some embodiments, the warranty claim option initiates a process to request a replacement hardware product in the event the hardware product is lost or stolen. In some embodiments, the electronic device does not display the warranty claim option if the warranty plan is expired or if the hardware product is not covered by warranty.

In some embodiments, in response to receiving the input corresponding to the selection of the support option, the electronic device (e.g., 500b) displays, via the display generation component, a support menu that includes a repair option that, when selected, causes the electronic device to initiate a process to schedule a repair of the hardware product, such as option 646c in FIG. 6O. In some embodiments, the process to schedule the repair of the hardware product includes displaying a user interface with available appointment times and locations. In some embodiments, the user is able to schedule an appointment for the hardware product to be repaired. In some embodiments, the electronic device displays the repair open irrespective of whether or not the hardware product is covered by a warranty plan.

In some embodiments, in response to receiving the input corresponding to the selection of the support option, the electronic device (e.g., 500b) displays, via the display generation component, a support menu that includes an agreement option that, when selected, causes the electronic device to display, via the display generation component, an agreement associated with the second subscription, such as option 646e in FIG. 6O. In some embodiments, the agreement is a lease agreement including the terms and conditions of access to the hardware product via the second subscription.

In some embodiments, in response to receiving the input corresponding to the selection of the support option, the electronic device (e.g., 500b) displays, via the display generation component, a support menu that includes a message option that, when selected, causes the electronic device to initiate a messaging conversation with support staff associated with the second subscription, such as option 646f in FIG. 6O. In some embodiments, the electronic device displays topic-specific messaging options in response to detecting selection of one or more of the selectable options described above, such as displaying a billing messaging option in response to detecting selection of the billing option or displaying technical support messaging option in response to detecting selection of the assistance option. In some embodiments, in response to detecting selection of the messaging option, the electronic device initiates a messaging conversation not associated with a particular topic or associated with a general topic. Displaying the support menu in response to receiving the input corresponding to the detecting selection of the support open enhances user interactions with the electronic device by reducing the number of inputs needed for the user to access specific user interfaces and/or user interface elements related to a respective issue.

In some embodiments, while displaying the subscription management user interface, the electronic device (e.g., 500b) receives, via the one or more input devices, an input corresponding to a request to view details about the second subscription that grants access to the hardware product, such as contact 603k in FIG. 6K. In some embodiments, receiving the input includes detecting selection of the indication of the second subscription. In some embodiments, receiving the input includes detecting a voice input, keyboard shortcut, or other input not directed to the indication of the second subscription.

In some embodiments, in response to receiving the input corresponding to the request to view details about the second subscription, the electronic device (e.g., 500b) displays, via the display generation component, a subscription details user interface for the second subscription that includes an option to initiate a process to subscribe to a second service, such as option 638 in FIG. 6L. In some embodiments, the subscription details user interface further includes one or more selectable options and/or user interface elements described above. In some embodiments, the second service is a digital content service or a software service. In some embodiments, the second service is a respective service based on one or more characteristics of the hardware product. For example, if the hardware product has a first configuration, the second service is a third service and if the hardware product has a second configuration, the second service is a fourth service. For example, if the hardware product is associated with a user account in a group of user accounts (e.g., a family group), the service is a family tier of a service that grants access to the service to all user accounts in the group of user accounts, and if the hardware product is not associated with a group of user accounts, the service is an individual tier of the service that grants access to the service to one user account. In some embodiments, the process to subscribe to the second service includes selecting subscription options, such as tier, subscription duration (e.g., how long before the third subscription renews), and number of users able to access the second service and confirming re-occurring payment for the third subscription. Displaying the option to initiate the process to subscribe to the second service enhances user interactions with the electronic device by reducing the number of inputs needed to subscribe to services relevant to the hardware product.

In some embodiments, the second subscription grants a first user access to the hardware product, such as the subscription corresponding to representation 628c in FIG. 6K. In some embodiments, the first user is the same person as the user of the electronic device. In some embodiments, the first user and the user of the electronic device are different people. In some embodiments, the hardware product is associated with a user account of the first user (e.g., the first user is “logged in” to the hardware product).

In some embodiments, displaying the subscription management user interface further includes concurrently displaying an indication of a third subscription associated with the user account, wherein the third subscription grants a second user different from the first user access to a second hardware product, such as the subscription corresponding to representation 628b in FIG. 6K. In some embodiments, the second user is the same person as the user of the electronic device. In some embodiments, the second user and the user of the electronic device are different people. In some embodiments, the hardware product is associated with a user account of the second user (e.g., the second user is “logged in” to the hardware product). In some embodiments, the subscription management user interface includes indications of subscriptions to access hardware products that are associated with different users. In some embodiments, the user of the electronic device is responsible for paying the subscription fees for access to the hardware products and is named on the lease agreements associated with the subscriptions for access to the hardware products, but other users are logged into the hardware products. For example, a corporation may subscribe to hardware products for its employees or a parent may subscribe to hardware products for their children. In some embodiments, the user of the electronic device previously sent invitation(s) to the other user(s) that include an option to initiate a process to order the hardware product that will be accessed using the second subscription, which is associated with the account of the user of the electronic device. In some embodiments, the other user logs into their user account on the hardware product, even if the subscription that grants access to the hardware product is associated with (e.g., managed by and/or paid by) the user account of the user of the electronic device. In some embodiments, the hardware product that is logged into a different user account from the user account that is subscribed to the second subscription that grants access to the hardware product displays a subscription details user interface for the second subscription that includes a subset of options and/or elements that are displayed in the subscription details user interface for the user that is the subscriber to the second subscription. Displaying indications of the second subscription that grants access to a hardware product for a first user and the third subscription that grants access to a second hardware product for a second user in the subscription management user interface enhances user interactions with the electronic device by enabling the user to quickly and efficiently view and make changes to hardware subscriptions for multiple users.

In some embodiments, in accordance with a determination that the user account is actively enrolled in the second subscription, the indication of the second subscription is displayed in an active subscription portion of the subscription management user interface, such as indication 628c in FIG. 6K. In some embodiments, the active subscription portion of the subscription management user interface further includes indications of one or more other subscriptions to services or to hardware products in which the user account is actively enrolled.

In some embodiments, in accordance with a determination that the access of the user account to the second subscription has been canceled, the indication of the second subscription is displayed in a canceled subscription portion of the subscription management user interface, such as indication 628c in FIG. 6S. In some embodiments, the canceled subscription portion of the subscription management user interface further includes indications of one or more other subscriptions to services or to hardware products to which access by the user account has been canceled. In some embodiments, the subscription management user interface includes separate sections for subscriptions that have been canceled but have not yet expired and for subscriptions that are expired. In some embodiments, the electronic device displays indications of subscriptions that have been canceled but have not yet expired in the active subscription portion of the subscription management user interface. In some embodiments, the electronic device displays indications of subscriptions that have been canceled but have not yet expired in the canceled subscription portion of the subscription management user interface. In some embodiments, in response to a sequence of inputs to cancel the second subscription according to one or more steps described above, the electronic device cancels the second subscription and displays the indication of the second subscription in the canceled subscription portion of the subscription management user interface. In some embodiments, the active subscription portion of the user interface is displayed with higher priority than the canceled subscription portion of the user interface, such as the active subscription portion being displayed above the canceled subscription portion. Displaying the indication of the second subscription in the active subscription portion of the subscription management user interface or the canceled subscription portion of the subscription management user interface enhances user interactions with the electronic device by reducing the time and inputs needed to view the status of the second subscription.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 702 and/or receiving operation 704 are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to present content of relevance to the user. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, determining current device usage can enable an electronic device to make recommendations for another electronic device to access using a hardware subscription. Accordingly, use of such personal information data enables users to view information that is relevant to them. Further, other uses for personal information data that benefit the user are also contemplated by the present disclosure. For instance, a current location can be used to recommend a store at which to pickup an electronic device for access via a hardware subscription.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable location services that determine the location of the electronic device and/or locations of other electronic devices and/or not to share information about current device usage.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the user can select options for a hardware device for access via a hardware subscription without providing current device usage.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
displaying, via the display generation component, a subscription management user interface that concurrently includes an indication of a first subscription associated with a user account of the electronic device, wherein the first subscription grants the user account access to a first service, and an indication of a second subscription associated with the user account of the electronic device, wherein the second subscription grants access to a hardware product;
while displaying the subscription management user interface, receiving, via the one or more input devices, one or more inputs corresponding to a request to revise the first subscription or the second subscription; and
in response to receiving the one or more inputs:
in accordance with a determination that the one or more inputs includes an input directed to the indication of the first subscription, initiating a process to revise the first subscription; and
in accordance with a determination that the one or more inputs includes an input directed to the indication of the second subscription, initiating a process to revise the second subscription.

2. The method of claim 1, further comprising:
displaying, via the display generation component, a hardware subscription user interface that includes:
an indication of a recommended hardware product having a respective configuration; and
a selectable option that, when selected, causes the electronic device to initiate a process to subscribe the user account to a hardware subscription that grants access to the recommended hardware product, wherein:
in accordance with a determination that the electronic device has a first configuration, the recommended hardware product has a second configuration based on the first configuration of the electronic device, and
in accordance with a determination that the electronic device has a third configuration different from the first configuration, the recommended hardware product has a fourth configuration different from the second configuration and based on the third configuration of the electronic device.

3. The method of claim 2, wherein:
in accordance with a determination that a first amount of storage is in use on the electronic device, the respective configuration includes a second amount of storage based on the first amount of storage, and
in accordance with a determination that a third amount of storage different from the first amount of storage is in use on the electronic device, the respective configuration includes a fourth amount of storage different from the second amount of storage based on the third amount of storage.

4. The method of claim 2, wherein:
in accordance with the first configuration including a first warranty plan, the second configuration includes a second warranty plan based on the first warranty plan, and
in accordance with the third configuration including a third warranty plan different from the first warranty plan, the fourth configuration includes a fourth warranty plan different from the second warranty plan and based on the third warranty plan.

5. The method of claim 2, wherein:
in accordance with a determination that the user account is using a first amount of remote storage, the respective configuration includes a second amount of storage based on the first amount of remote storage, and
in accordance with a determination that the user account is using a third amount of remote storage different from the first amount of remote storage, the respective configuration includes a fourth amount of storage different from the second amount of storage based on the third amount of remote storage.

6. The method of claim 2, wherein the hardware subscription user interface further includes:
in accordance with the determination that the electronic device has the first configuration, an indication of a reason why the second configuration is recommended for the hardware product based on the first configuration, and
in accordance with the determination that the electronic device has the third configuration, an indication of a reason why the fourth configuration is recommended for the hardware product based on the third configuration.

7. The method of claim 1, further comprising:
while displaying the indication of the second subscription that grants access to the hardware product in the subscription management user interface:
in accordance with a determination that a device upgrade is available for the second subscription, displaying, via the display generation component, an indication that the device upgrade is available in the subscription management user interface; and
in accordance with a determination that the device upgrade is not available for the second subscription, forgoing displaying the indication in the subscription management user interface.

8. The method of claim 1, further comprising:
while the user account is actively enrolled in the second subscription that grants access to the hardware product, displaying, via the display generation component, a settings user interface that includes:
a selectable option that, when selected, causes the electronic device to initiate a process to change a setting of the electronic device; and
in accordance with a determination that a device upgrade is available for the second subscription, an indication that the device upgrade is available, wherein in accordance with a determination that the device upgrade is not available for the second subscription, the settings user interface does not include the indication in the subscription management user.

9. The method of claim 1, wherein displaying the subscription management user interface including the indication of the first subscription and the indication of the second subscription includes:
displaying, in the indication of the first subscription, an indication of a name of the first service of the first subscription, an indication of a tier of the first subscription, an indication of a next renewal date of the first subscription, and an indication of a renewal price of the first subscription; and
displaying, in the indication of the second subscription, an indication of a nickname of the hardware product, an indication of a configuration of the hardware product, an indication of a next renewal date of the second subscription, and an indication of a renewal price of the second subscription.

10. The method of claim 1, further comprising:
while displaying the subscription management user interface, receiving, via the one or more input devices, an input corresponding to a request to view details about the second subscription that grants access to the hardware product; and
in response to receiving the input:
displaying, via the display generation component, a subscription details user interface for the second subscription that includes an indication of a device upgrade associated with the second subscription, wherein:
in accordance with a determination that one or more criteria are satisfied, the indication of the device upgrade includes an indication that the user account is eligible for a no-cost device upgrade; and
in accordance with a determination that the one or more criteria are not satisfied, the indication of the device upgrade includes an indication of a price to upgrade the hardware product today and an indication of a date on which the user account will be eligible for the no-cost upgrade.

11. The method of claim 1, further comprising:
while displaying the subscription management user interface, receiving, via the one or more input devices, an input corresponding to a request to view details about the second subscription that grants access to the hardware product;
in response to receiving the input corresponding to the request to view details about the second subscription, displaying, via the display generation component, a subscription details user interface for the second subscription that includes an indication of a warranty plan associated with the second subscription;
while displaying the subscription details user interface including the indication of the warranty plan, receiving, via the one or more input devices, a user input corresponding to selection of the indication of the warranty plan; and
in response to receiving the user input corresponding to the selection of the indication of the warranty plan, initiating a process to change the warranty plan associated with the second subscription.

12. The method of claim 1, further comprising:
while displaying the subscription management user interface, receiving, via the one or more input devices, an input corresponding to a request to view details about the second subscription that grants access to the hardware product;
in response to receiving the input corresponding to the request to view details about the second subscription, displaying, via the display generation component, a subscription details user interface for the second subscription that includes a plurality of user interface elements related to the second subscription, including, in accordance with a determination that the user account is actively enrolled in the second subscription:
a transaction history option that, when selected, causes the electronic device to display indications of transactions related to the second subscription;
a support option that, when selected, causes the electronic device to initiate a process to get support related to the hardware product accessed through the second subscription;
a cancelation option that, when selected, causes the electronic device to initiate a process to cancel the second subscription; and
an indication of terms of canceling the second subscription.

13. The method of claim 12, wherein displaying, via the display generation component, the subscription details user interface for the second subscription includes, in accordance with a determination that the access of the user account to the second subscription has been canceled, displaying a subset of the plurality of user interface elements.

14. The method of claim 1, further comprising:
while displaying the subscription management user interface, receiving, via the one or more input devices, an input corresponding to a request to view details about the second subscription that grants access to the hardware product;
in response to receiving the input corresponding to the request to view details about the second subscription, displaying, via the display generation component, a subscription details user interface for the second subscription that includes a support option;
while displaying the subscription details user interface for the second subscription, receiving, via the one or more input devices, an input corresponding to selection of the support option; and
in response to receiving the input corresponding to the selection of the support option, displaying, via the display generation component, a support menu that includes:
an assistance option that, when selected, causes the electronic device to initiate a process to receive assistance resolving a technical difficulty with the hardware product;
an information option that, when selected, causes the electronic device to initiate a process to update user information associated with the second subscription;
a billing option that, when selected, causes the electronic device to initiate a process to view or update billing information for the second subscription;
a warranty claim option that, when selected, causes the electronic device to initiate a process to file a claim using a warranty plan associated with the second subscription;
a repair option that, when selected, causes the electronic device to initiate a process to schedule a repair of the hardware product;
an agreement option that, when selected, causes the electronic device to display, via the display generation component, an agreement associated with the second subscription; and
a message option that, when selected, causes the electronic device to initiate a messaging conversation with support staff associated with the second subscription.

15. The method of claim 1, further comprising:
while displaying the subscription management user interface, receiving, via the one or more input devices, an input corresponding to a request to view details about the second subscription that grants access to the hardware product; and
in response to receiving the input corresponding to the request to view details about the second subscription, displaying, via the display generation component, a subscription details user interface for the second subscription that includes an option to initiate a process to subscribe to a second service.

16. The method of claim 1, wherein:
the second subscription grants a first user access to the hardware product, and
displaying the subscription management user interface further includes concurrently displaying an indication of a third subscription associated with the user account, wherein the third subscription grants a second user different from the first user access to a second hardware product.

17. The method of claim 1, wherein:
in accordance with a determination that the user account is actively enrolled in the second subscription, the indication of the second subscription is displayed in an active subscription portion of the subscription management user interface, and in accordance with a determination that the access of the user account to the second subscription has been canceled, the indication of the second subscription is displayed in a canceled subscription portion of the subscription management user interface.

18. An electronic device in communication with a display generation component and one or more input devices, the electronic device comprising:
one or more processors;
memory; and
one or more programs, wherein the one or more programs are stored in the memory and configured to be executed by the one or more processors, the one or more programs including instructions for:
displaying, via the display generation component, a subscription management user interface that concurrently includes an indication of a first subscription associated with a user account of the electronic device, wherein the first subscription grants the user account access to a first service, and an indication of a second subscription associated with the user account of the electronic device, wherein the second subscription grants access to a hardware product;
while displaying the subscription management user interface, receiving, via the one or more input devices, one or more inputs corresponding to a request to revise the first subscription or the second subscription; and
in response to receiving the one or more inputs:
in accordance with a determination that the one or more inputs includes an input directed to the indication of the first subscription, initiating a process to revise the first subscription; and
in accordance with a determination that the one or more inputs includes an input directed to the indication of the second subscription, initiating a process to revise the second subscription.

19. A non-transitory computer readable storage medium storing one or more programs, the one or more programs comprising instructions, which when executed by one or more processors of an electronic device in communication with a display generation component and one or more input devices, cause the electronic device to perform a method comprising:
displaying, via the display generation component, a subscription management user interface that concurrently includes an indication of a first subscription associated with a user account of the electronic device, wherein the first subscription grants the user account access to a first service, and an indication of a second subscription associated with the user account of the electronic device, wherein the second subscription grants access to a hardware product;
while displaying the subscription management user interface, receiving, via the one or more input devices, one or more inputs corresponding to a request to revise the first subscription or the second subscription; and
in response to receiving the one or more inputs:
in accordance with a determination that the one or more inputs includes an input directed to the indication of the first subscription, initiating a process to revise the first subscription; and
in accordance with a determination that the one or more inputs includes an input directed to the indication of the second subscription, initiating a process to revise the second subscription.
